(19) United States
(12) Patent Application Publication
(10) Pub. No.: US 2002/0023005 A1
(43) Pub. Date: Feb. 21, 2002

(54) Electronic cash register system

(76) Inventors: Hiroyuki Tanaka, Yokohama-shi (JP); Kesayoshi Iguchi, Fujisawa-shi (JP)

Correspondence Address: LAW OFFICES OF LOUIS WOO, 1901 North Fort Myer Drive, Suite 501, Arlington, VA, 22209, US

(21) Appl. No.: 09/903,567

(22) Filed: Jul. 13, 2001

(30) Foreign Application Priority Data
Aug. 15, 2000 (JP) 2000-246504

(51) Int. Cl. G06G 1/14; G06F 17/60

(52) U.S. Cl. 705/22

(57) ABSTRACT

The number of articles to be prepared after a predetermined interval is predicted according to the number of articles ordered for a just before unit interval in response to order data from an electronic cash register, the number of stocked articles for said just before unit interval, the average number of articles sold for a just before interval including the just before unit interval. The predicted number is displayed according to a peak time zone, a day of week, and the present time. This display mode may be selectively switched to the conventional display mode displaying the number of articles to be prepared. The maximum number may limit the predicted number. Historic data for prediction may be stored and outputted (recorded, printed, or transmitted). The predicted number may be displayed on different areas for every type of articles.

### BACKGROUND OF THE INVENTION

1. Field of the Invention

This invention relates to an electronic cash register system including at least an electronic cash register and a display controller for displaying the ordered articles from the electronic cash register.

2. Description of the Prior Art

An electronic cash register system including at least an electronic cash register and a display controller for displaying the ordered articles from the electronic cash register is known. In this prior art electronic cash register system, customer's orders are transmitted to a kitchen to display the orders to prepare the ordered articles with the display controller with a display. FIG. 41 is a block diagram of a prior art electronic cash register system. The prior art electronic cash register system includes electronic cash registers (ECR) 411, a communication path 412, a kitchen video controller (KVC) 413, a monitor display 414, and a monitor switch 415.

FIG. 42 is an illustration of a monitor switch 415 of the prior art electronic cash register system. The monitor switch 415 includes a holding key 421, a rotating key 422, and a served key 423.

FIG. 43 is an illustration of the prior art electronic cash register system showing example images of customer's orders. The customer's orders are displayed on the monitor display 414 in order of time. Display image 432 represents two-set-prior orders, display image 433 represents one-set-prior orders, and display image 434 represents the present orders. FIG. 44 is an illustration of the prior art electronic cash register system showing later images of customer's orders. In FIG. 44, the oldest set of the orders in FIG. 43 has been erased.

In the prior art electronic cash register system at a restaurant or the like, article data is registered with the electronic cash register 411. The article data is transmitted to the kitchen video controller 413 through the communication path 412. The kitchen video controller 413 displays the article data received from the electronic cash register 411 on the monitor display 414 as shown in FIGS. 43 and 44. The cooks prepare articles with monitoring the monitor display 414. When a cook has finished preparing the articles, the cook depresses the monitor switch 423 to erase the display image of the corresponding set of orders.

The holding key 421 of the monitor switch 415 is a stacking key for shifting the display image of one set of orders to another place on the screen of the monitor display 414 when it will take for a long time period to prepare the corresponding articles.

The rotating key 421 of the monitor switch 415 is a key for swapping the display image of one set of order with the next order on the screen of the monitor display 414 when the preparing order is changed. The served key 423 is a key for erasing the data of order and erasing the display image of the order. When the served key 423 is depressed, the display image is changed as shown in FIG. 44 from the image shown in FIG. 43.

### SUMMARY OF THE INVENTION

The aim of the present invention is to provide a superior electronic cash register system.

According to the present invention, a first aspect of the present invention provides an electronic cash register system comprising: a display controller having a display and an electronic cash register, said display controller includes: receiving means for receiving order data from said electronic cash register, said order data including the number of articles; first means for obtaining the number of articles ordered for a just before unit interval in response to said order data from said receiving means; second means for obtaining the number of stocked articles for said just before unit interval; third means for obtaining the number of pending articles to be prepared for said just before unit interval; fourth means for obtaining the averaged number of articles sold for a just before interval including said just before unit interval using said first means; prediction means for predicting the number of articles to be prepared after a predetermined interval in accordance with data from said first to fourth means; and displaying means for displaying result of said predicted the number on said display.

According to the present invention, a second aspect of the present invention provides the electronic cash register system based on the first aspect, wherein said order data further includes a type of said articles and said display controller further comprises: means response to an operation by a user for specifying each type of said articles as to whether the number of each type of said articles is predicted by said prediction means.

According to the present invention, a third aspect of the present invention provides the electronic cash register system based on the first aspect, wherein said order data further includes a type of said articles and said display controller further comprises: setting means for setting the tentative (prospective) number of each type of said articles, which is used by said prediction means until said fourth means can obtain the average number of articles sold for said interval.

According to the present invention, a fourth aspect of the present invention provides the electronic cash register system based on the third aspect, wherein said display controller further comprises: a plurality of setting means, each for setting the different tentative number of each type of said articles, which is used by said prediction means until said fourth means can obtain the average number of articles sold for said interval, and selecting means for selectively supplying to said fourth means the different tentative number of each type of said articles from one of said setting means selected in accordance with a condition.

According to the present invention, a fifth aspect of the present invention provides the electronic cash register system based on the first aspect, wherein said display controller further comprises a maximum number setting means for setting and storing the maximum number for said articles, wherein said displaying means displays said result when the number of articles does not exceed said maximum number and displays said maximum number of said articles when said result exceeds said maximum number.

According to the present invention, a sixth aspect of the present invention provides the electronic cash register system based on the first aspect, wherein said display controller further comprises: second displaying means for displaying data of articles ordered from said electronic cash register; mode switching means for switching a first display mode by said display means using said prediction means and a second display mode by said second display means and in response to a display mode switching signal.

According to the present invention, a seventh aspect of the present invention provides the electronic cash register system based on the sixth aspect, wherein said display controller further comprises: setting means for setting a time zone of operating said prediction means; clock means for generating a time signal representing the present time; mode switching signal generation means for generating said display mode switching signal when said present time is at said time zone.

According to the present invention, an eighth aspect of the present invention provides the electronic cash register system based on the sixth aspect, wherein said display controller further comprises: mode switching signal generation means for generating said display mode switching signal in response to a rotary switch connected to said video kitchen controller.

According to the present invention, a ninth aspect of the present invention provides the electronic cash register system based on the sixth aspect, wherein said display controller further comprises: setting means for setting a plurality of different time zones; selecting means for selecting one of said different time zones in response to a selection signal; clock means for generating a time signal representing the present time; and mode switching signal generation means for generating said display mode switching signal when said present time is at said selected one of said different time zone.

According to the present invention, a tenth aspect of the present invention provides the electronic cash register system based on the sixth aspect, wherein said electronic cash register further comprises: display mode switching signal generation means for generating a display mode switching signal in response to switching command; and transmission means for transmitting said display mode switching signal and said display controller further comprises: receiving means for receiving said display mode switching signal to supply said display mode switching signal to said mode switching means.

According to the present invention, an eleventh aspect of the present invention provides the electronic cash register system based on the first aspect, wherein said display controller further comprises: historic data storing means for storing said data as historic data; and outputting means for outputting said historic data in response to an output command.

According to the present invention, a twelfth aspect of the present invention provides the electronic cash register system based on the eleventh aspect, wherein said outputting means includes transmission means for transmitting said historic data in response to said output command, said electronic cash register further includes receiving means for receiving said historic data and printing means for printing said historic data.

According to the present invention, a thirteenth aspect of the present invention provides the electronic cash register system based on the eleventh aspect, wherein said display controller further comprises: historic data display means for displaying said historic data from said historic data storing means in response to a key switch.

According to the present invention, a fourteenth aspect of the present invention provides the electronic cash register system based on the first aspect, wherein said display controller further comprises: storing means for storing group codes, each code indicating resemble types of said articles, and said displaying means displaying said result at different areas in accordance with said group codes.

According to the present invention, a fifteenth aspect of the present invention provides the electronic cash register system based on the first aspect, wherein said display controller includes: stocked article data storing means for storing the number of articles of which the number is predicted by said prediction means; time limit storing means for storing time limit data of said articles; passage time measuring means for measuring passed time of said articles of which the number is predicted by said prediction means; judging means for judging whether said measured passed time of said articles exceeds said time limit data; and subtracting means for subtracting the number of articles judged that said measured passed time exceeds said time limit data from the number of stocked articles.

According to the present invention, a sixteenth aspect of the present invention provides the electronic cash register system based on the sixth aspect, wherein said display controller further comprises: display mode switching signal generation means for generating said display mode switching signal in response to a key switch connected to said video kitchen controller.

According to the present invention, a seventeenth aspect of the present invention provides the electronic cash register system based on the sixth aspect, wherein said clock means further generates a date signal indicative of a day of a week, and said selection signal selects one of said different time zone in response to said date signal as said selection signal.

According to the present invention, an eighteenth aspect of the present invention provides the electronic cash register system based on the eleventh aspect, wherein said outputting means includes a recording means for recording said historic data in a recording medium.

### BRIEF DESCRIPTION OF THE DRAWINGS

The object and features of the present invention will become more readily apparent from the following detailed description taken in conjunction with the accompanying drawings in which:

FIG. 1 is a block diagram of an electronic cash register system according to a first embodiment of the present invention;

FIG. 2A is an illustration showing data format of the unit intervals memory according to the first embodiment;

FIG. 2B is a time chart for predicting the number of articles necessary after a predetermined interval according to the first embodiment;

FIG. 3 is a plan view of the monitor switch shown in FIG. 1;

FIG. 4 depicts a flow chart showing outline process executed by the kitchen video controller according to the first embodiment;

FIG. 5 is an illustration showing a screen image on the display according to the first embodiment;

FIG. 6 is a block diagram of an electronic cash register system according to the second embodiment;

FIG. 7 is an illustration showing a data format for the article setting memory according to the second embodiment;

FIG. 8 depicts a flow chart showing the prediction processing according to the second embodiment;

FIG. 9 is an illustration showing a table in the article setting memory according to a third embodiment;

FIG. 10 is an illustration showing a table in the article setting memory according to a fourth embodiment;

FIG. 11 depicts a partial flow chart of processing in the kitchen video controller according to the fourth embodiment;

FIG. 12 is an illustration showing a table in the article setting memory according to a fifth embodiment;

FIG. 13 depicts a partial flow chart of processing in the kitchen video controller according to the fifth embodiment;

FIG. 14 is a block diagram of an electronic cash register system according to the sixth embodiment;

FIG. 15 is a plan view of the monitor switch according to the sixth embodiment;

FIG. 16 depicts a flow chart showing a mode changing operation according to the sixth embodiment;

FIG. 17 is a block diagram of an electronic cash register system according to a seventh embodiment;

FIG. 18 is an illustration of a table in a peak time setting memory according to the seventh embodiment;

FIG. 19 depicts a flow chart showing a mode changing operation according to the seventh embodiment;

FIG. 20 is an illustration of the rotary switch according to an eighth embodiment;

FIG. 21 depicts a flow chart of the display mode changing operation according to the eighth embodiment;

FIG. 22 is an illustration showing a table in the peak time zone setting memory according to a ninth embodiment;

FIG. 23 depicts a flow chart of display mode changing operation according to the ninth embodiment;

FIG. 24A is a block diagram of an electronic cash register according to a tenth embodiment;

FIG. 24B depicts a flow chart of display mode changing operation from an electronic cash register according to the tenth embodiment;

FIG. 25 depicts a flow chart of receiving a command from the electronic cash register according to the tenth embodiment;

FIG. 26 is a block diagram of an electronic cash register system according to an eleventh embodiment;

FIG. 27 is a table storing the historic data according to the eleventh embodiment;

FIG. 28 depicts a partial flow chart of display operation according to the eleventh embodiment;

FIG. 29A is a block diagram of an electronic cash register according to a twelfth embodiment.

FIG. 29B is an illustration showing historic data according to the twelfth embodiment;

FIG. 30 is an illustration of printed sheet according to the twelfth embodiment;

FIG. 31 depicts a partial flow chart showing transmission operation in the display operation according to the twelfth embodiment;

FIG. 32 depicts a flow chart of an electronic cash register according to the twelfth embodiment;

FIG. 33 is a plan view of the monitor switch according to a thirteenth embodiment;

FIG. 34 is an illustration of the screen of the display according to the thirteenth embodiment;

FIG. 35 shows the group setting table according to a fourteenth embodiment;

FIG. 36 depicts a partial flow chart of display operation according to the fourteenth embodiment

FIG. 37 is an illustration of display screen of the display;

FIG. 38 is an illustration of time limits respective articles according to a fifteenth embodiment;

FIG. 39 is an illustration of passed time of stocked articles according to the fifteenth embodiment;

FIG. 40 depicts a flow chart showing abandon operation according to the fifteenth embodiment;

FIG. 41 is a block diagram of a prior art electronic cash register system;

FIG. 42 is an illustration of a prior art monitor switch 423 of the prior art electronic cash register system;

FIG. 43 is an illustration of the prior art electronic cash register system showing example images of customer's orders; and

FIG. 44 is an illustration of the prior art electronic cash register system showing later images of customer's orders.

The same or corresponding elements or parts are designated with like references throughout the drawings.

### DETAILED DESCRIPTION OF THE INVENTION

[First Embodiment]

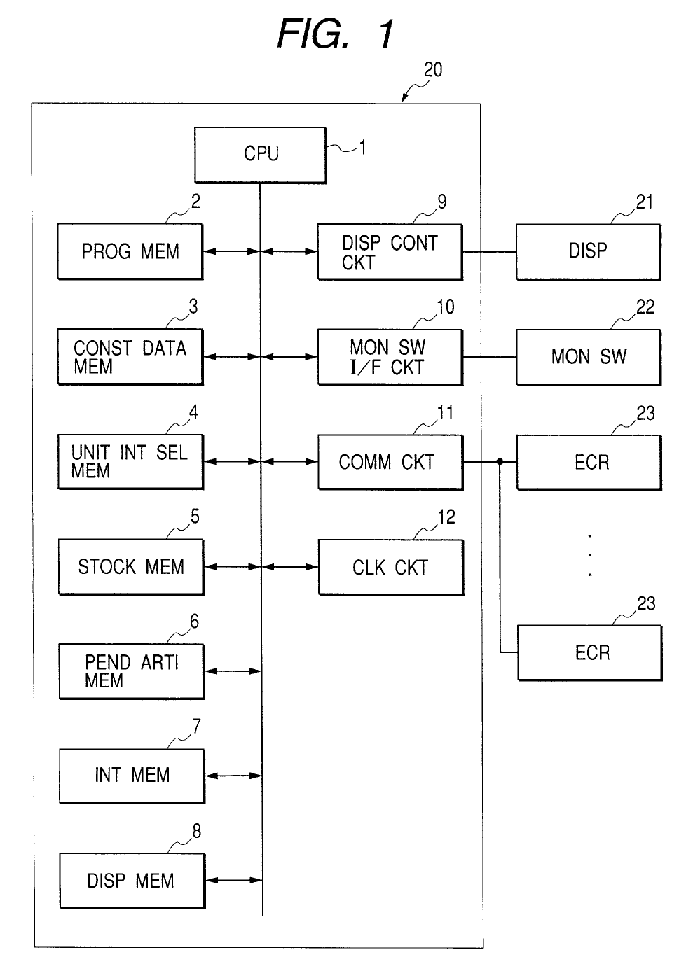

FIG. 1 is a block diagram of an electronic cash register system according to the present invention. The electronic cash register system includes a plurality of electronic cash registers 23 and a kitchen video controller 20 having a display 21 and monitor switch 22. The kitchen video controller 20 includes a CPU 1, a program memory 2, a constant data memory 3, a 4, a stock memory 5, a pending memory 6, an interval memory 7, a display memory 8, a display control circuit 9, a monitor switch interface circuit 10, a communication circuit 11 for communicating with the electronic cash registers 23, a clock circuit 12 for generating a time signal and a date signal.

The CPU 1 in the kitchen video controller 20 effects calculation, and other functions such as controlling inputting and outputting data in accordance with programs stored in the program memory 2. Particularly, the CPU 1 predicts the number of articles which is necessary after a predetermined interval in accordance with the stored data, and other functions. The constant data memory 3 stores the average number of articles which have been sold for a plurality of just passed unit intervals to predict the number of productions. The unit interval selling memory 4 stores the number of sold articles for a just passed unit interval. A stock memory 5 stores the number of stocked articles for the just passed unit interval. The pending article memory 6 stores the number of articles which have been ordered but have not prepared (produced) for the just passed unit interval. The interval memory 7 stores a plurality of sets of data of the number of sold articles for the unit interval. The display memory 8 stores video data to be displayed on the display 21 coupled to this kitchen video controller 20. The display control circuit 9 outputs the video data to the display 21 from the display memory 8. The monitor switch interface circuit 10 inputs data from the monitor switch 22. The communication circuit 11 communicates with each of electronic cash registers 23. The clock circuit 12 generates the clock signal indicative of the present time and the date signal indicative of the today's date and the day of weak.

Operation according to the first embodiment will be described with the assumption that it takes five minutes to prepare an article, the number of actually sold articles for fifteen minutes are calculated, and the number of selling articles after five minutes from the present time is predicted from the averaged number of articles sold for just before fifteen minutes.

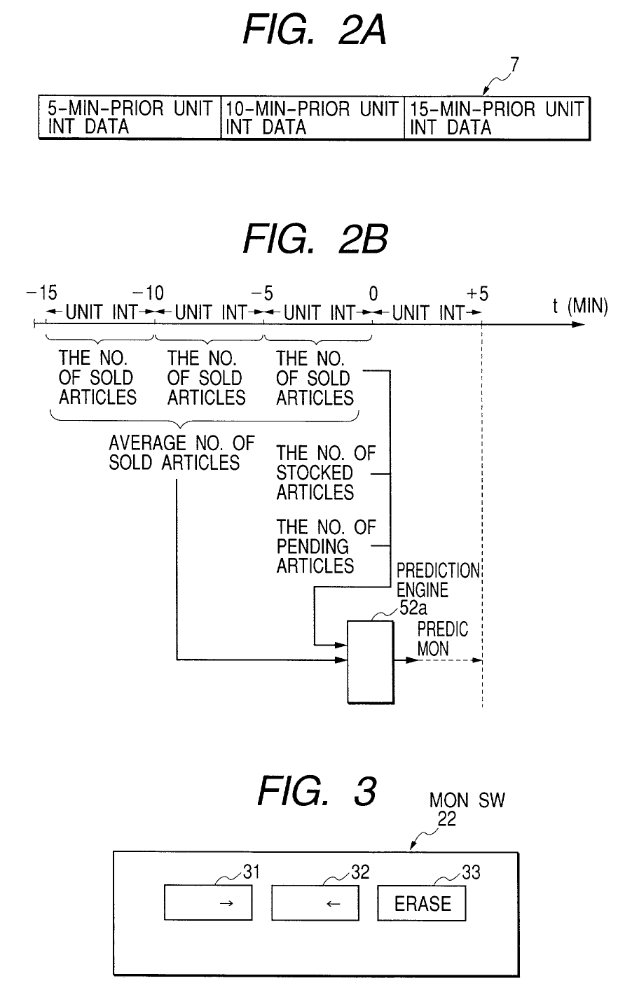

FIG. 2A is an illustration showing data format of the interval memory 7. The interval memory 7 stores a plurality of sets of unit interval data, that is, five-minute prior unit interval data, ten-minutes prior unit interval data, and fifteen-minute prior unit interval data in order of time. The five-minute prior unit interval data includes the number of articles which have been sold just before five minutes. The ten-minute prior unit interval data includes the number of articles which was sold for the second prior unit interval, that is, sold from ten to five minutes before. The ten-minute prior unit interval data includes the number of articles which was sold for the second prior unit interval, that is, sold from ten to five minutes before.

FIG. 2B is a time chart for predicting the number of articles necessary after a predetermined interval according to the first embodiment.

The program memory 2 includes a program for a prediction engine 52a. The prediction engine 52a predicts the number of each type of articles which is necessary after a predetermined interval (+5 MIN) from now from the number of each type of articles which were sold for just before unit interval (−5 to 0 MIN), the number of each type of articles which were stocked for the just before unit interval, the number of each type of articles which were pending for the just before unit interval, and the average number of articles which were sold for consecutive unit intervals (−15 −0 MIN). The number of each type of articles which is necessary after the predetermined interval (+5 MIN) which agrees with the just before unit interval. However, this predetermined interval can be changed. If the prediction engine 52a predicts the number of each type of articles only with the data for just before unit interval (−5 to 0 MIN), prediction may be inaccurate. Thus, the variation in the number of sold articles for the just before interval (−15 to 0 MIN) is further considered.

FIG. 3 is a plan view of the monitor switch 22 shown in FIG. 1. The monitor switch 22 includes a right direction scroll key 31, a left direction scroll key 32, and an erase key 33. The right direction scroll key 31 shifts a cursor on the screen of the display 21 in the right direction by one order or one slot. The left direction scroll key 32 shifts the cursor on the screen of the display 21 in the left direction by one order or one slot. The clear key 33 erases the article indicated by the cursor on the screen.

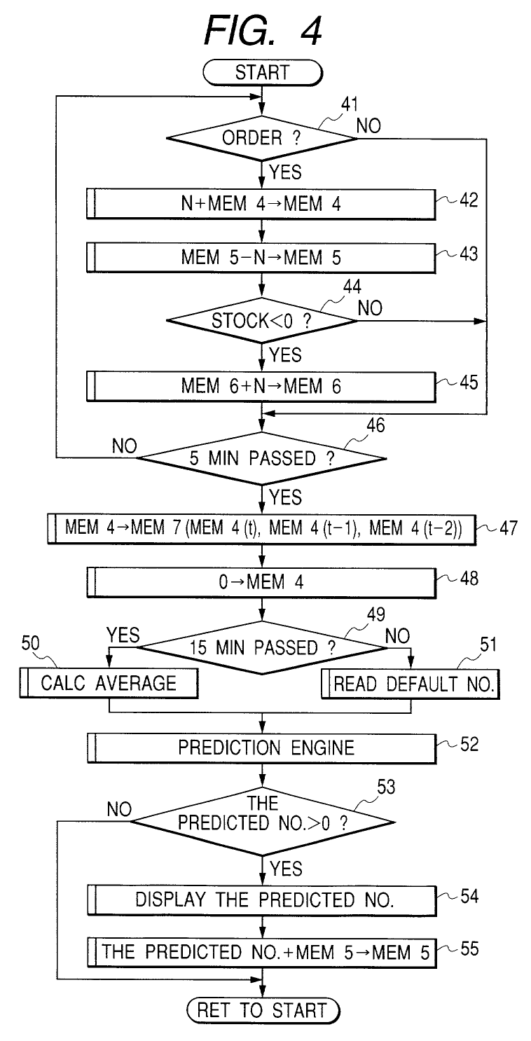

FIG. 4 depicts a flow chart showing outline process executed by the kitchen video controller 20 to display the predicted number of articles to be prepared. In step 41, the CPU 1 judges whether an article(s) is sold. If an article has been sold (YES), processing proceeds to sate 42. If NO, processing proceeds to step 46, where the CPU adds the number N of the sold articles to the number of sold article for the unit interval and stores the number in the unit interval selling memory 4 (N being a natural number). In the following step 43, the CPU 1 subtracts the number of sold articles from the number N of articles in the stock memory 5 to renew the number of stocked articles. In step 44, the CPU 1 judges whether the number of the article in the stock memory 5 is lower than zero. If the number of the article in the stock memory 5 is equal to or higher than zero (NO in step 44), processing proceeds to step 46. If YES in step 44, processing proceeds to step 45. In step 45, because the number of the stocked articles is lower than number N of the sold articles, the number of the sold articles or the number of shortage is added to the data in the pending article memory 6, and processing proceeds to step 46.

In step 46, the CPU 1 judges whether five minutes as the unit interval has passed. If the unit interval has passed, processing proceeds to step 47 (YES). If NO, processing returns to step 41.

In step 47, the CPU 1 stores the number N of the sold articles in the unit interval in the unit intervals memory 7 such that as shown in FIG. 2, the old respective prior unit interval data is shifted in the right direction and erases the old fifteen-minute prior unit interval data and the number of the sold articles is stored at the space as the five-minute prior unit interval data, and processing proceeds to step 48.

In step 48, the CPU 1 clears the data in the unit interval selling memory 4, and processing proceeds to step 49.

In step 49, the CPU 1 judges whether it has passed more than fifteen minutes after start of process of selling. If it has passed more than fifteen minutes, processing proceeds to step 50 (YES). If NO, processing proceeds to step 51.

In step 50, the CPU 1 calculates the total and the average of the number of sold articles just before fifteen minutes from the data in the interval memory 7, and processing proceeds to step 52.

In step 51, the CPU 1 reads the default number (tentative number) instead of the averaged number of selling articles from the constant data memory 3 because the data for fifteen minutes in the interval memory 7 has not be fully stored, and processing proceeds to step 52, and processing proceeds to step 52.

In step 52, the CPU 1 executes processing of prediction engine. That is, the CPU 1 obtains the predicted number of articles to be prepared from the number of sold articles from the unit interval selling memory 4, the number of stocked articles in the stock memory 5, the number of pending articles in the pending article memory 6, the averaged number of articles from the unit intervals memory 7, and a constant margin, and processing proceeds to step 53.

In step 53, the CPU 1 judges whether the predicted number of articles to be prepared (production) is higher than zero. If the predicted number is higher than zero, processing proceeds to step 54 (YES). If NO, processing proceeds to step 41.

In step 54, the CPU 1 displays the predicted number of articles to be prepared on the display 21, and processing proceeds to step 55.

In step 55, the CPU 1 adds the predicted number of articles to be prepared to the data in the stock memory 5, and processing returns to step 41.

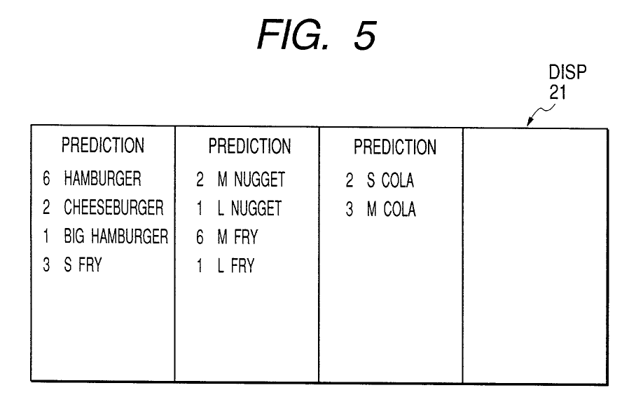

FIG. 5 is an illustration showing a screen image on the display according to the first embodiment. As shown in FIG. 5, the predicted number of the articles to be prepared is displayed on the screen of the display 21. The cook (operator) prepares the articles indicated on the screen. When the cook has finished preparing the article, the cook operates the right direction scroll key 31 and the left direction scroll key 32 to select the articles on the screen corresponding to the actually prepared articles and erases the data of the articles with the erase key 33.

As mentioned above, according to the first embodiment, the kitchen video controller 20 predicts the number of the necessary articles after a predetermined interval (one unit interval) from the number of article sold for just before unit interval, the number of stocked articles for just before interval, the number of pending articles for just before unit interval, and the number of articles sold for consecutive unit intervals including just before unit interval to display the predicted number of articles to be prepared after a predetermined interval (the unit interval). Thus, the cook can know the number of articles to be prepared after a predetermined interval. Accordingly, the kitchen video controller 20 executes prediction that was done by an experienced cook, so that a cook having no experience can properly prepare the articles in advance. Prediction is repeatedly made if a plurality of types of articles are processed. Thus, the predicted numbers of a plurality of types of articles are displayed as shown in FIG. 5.

[Second Embodiment]

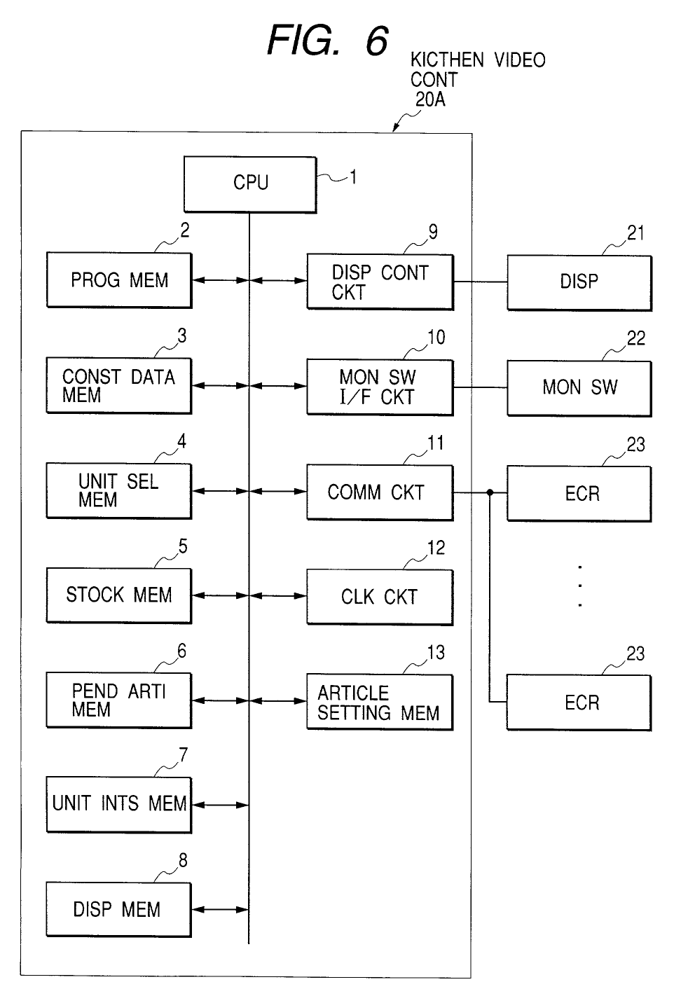

FIG. 6 is a block diagram of an electronic cash register system according to the second embodiment. The electronic cash register system according to the second embodiment has substantially the same structure as that of the first embodiment. The difference is in that an article setting memory 13 is further provided. Thus, this structure will be mainly described.

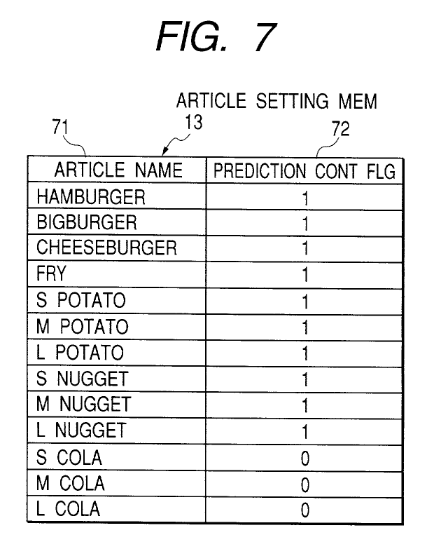

FIG. 7 is an illustration showing a data format for the article setting memory 13. The article setting memory 13 stores various article names 71 and correspondingly stores prediction control flags 72. The prediction control flag 72 having a value of 1 indicates that the number of this type of articles to be prepared is should be predicted. The prediction control flag 72 having a value of zero indicates that the number of this type of articles to be prepared is should not be predicted. In the first embodiment, all articles such as humbuggers, or potatoes were subjected to prediction. On the other hand, in the second embodiment, some articles are excluded from the group of articles which are subjected to the prediction. For example, cola can be prepared by only pouring it in a cap so that preparation is unnecessary. Moreover, toys can be soled with any preparation operation. These articles are excluded from the group.

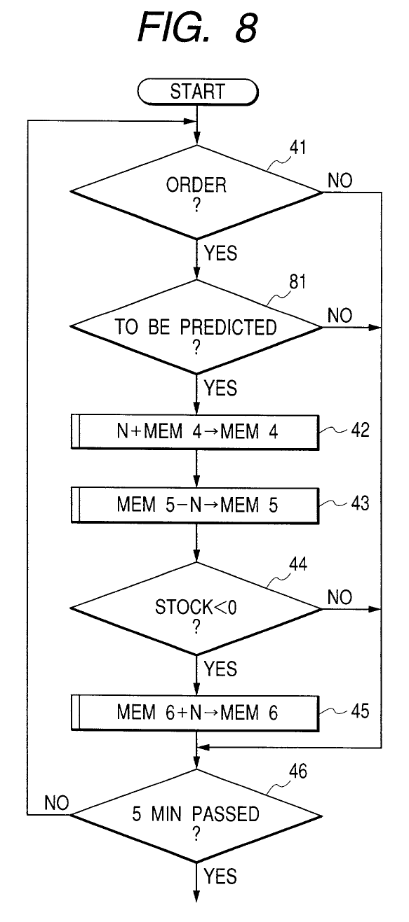

FIG. 8 depicts a flow chart showing the prediction processing according to the second embodiment. This process is substantially the same as that shown in FIG. 4. Thus, the same steps are designated with the same step numbers. The difference is that step 81 is further provided.

In step 41, the CPU 1 judges whether articles have been sold, that is, there is order. In the following step 81, the CPU 1 judges whether the articles should be subjected to the prediction process by checking the prediction control flag 72. If the article is to be subjected to the prediction, processing proceeds to step 42 (YES). If NO, processing proceeds to step 46.

In step 42, the CPU 1 adds the number of articles to the data in the unit interval selling memory 4. Next, the CPU 1 executes the same processing as the first embodiment.

As mentioned above, according to the second embodiment, the kitchen video controller 20A has the article setting memory 13 storing the prediction control flags with correspondence with the article names. The predication control flags indicates whether the prediction should be made. Thus, prediction is made only for the articles which need preparing time intervals. Thus, the display image on the display 21 is made clear. The prediction control flags can be set by operating the operation panel of the electronic cash register 23. Moreover, a keyboard may be provided to the kitchen video controller 20A to input the prediction control flags.

[Third Embodiment]

The electronic cash register system according to the third embodiment has substantially the same structure as that of the second embodiment. The difference is in that an article setting memory 13 stores initial averaged (tentative) number of selling articles for prediction at the initial interval of the day.

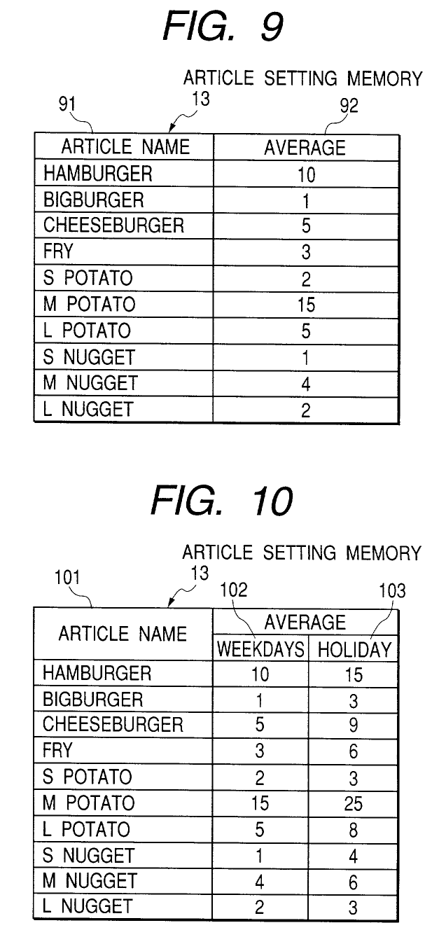

FIG. 9 is an illustration showing a table in the article setting memory 13 according to the third embodiment. The article setting memory 13 stores various article names 91 and correspondingly stores the initial average numbers 92 of articles (at unit interval) which are previously obtained.

At the initial stage, that is, the interval from the beginning of production within fifteen minutes, the prediction cannot be obtained from the actual number of sold articles. Thus, the number of the articles for prediction at the initial stage is provided from the initial averaged number 92 of articles. This is previously set in the article setting memory 13 by operating the operation panel of the electronic cash register 23. Moreover, a keyboard may be provided to the kitchen video controller 20A to input the prediction control flags.

In the first embodiment, at the initial stage, the CPU 1 reads the default value stored in the constant data memory 3 before shipment and uses it to predict the numbers of articles. On the other hand, in the second embodiment, the CPU 1 uses the average numbers of articles instead default value in step 51 in the flow chart shown in FIG. 4 to provide more accurate the number of articles to be prepared at every shop. The initial average number is obtained from the number of articles which were actually sold at this shop at the initial stage (for example, 15 minutes) at a weekday, a holiday, or a special sale day. So, the prediction numbers of articles to be prepared at the initial stage can be adjusted in accordance with the day of week or seasons.

As mentioned above, the kitchen video controller 20A has the function for setting the initial average number of articles for prediction at the initial stage, so that the prediction accuracy can be improved for the articles of which the number varies with the day of week or for the articles which are not sold at off-season. That is, the prediction accuracy can be improved though the averaged number of articles sold at the initial stage may vary in accordance with the condition of the day. Prediction is repeatedly made if a plurality of types of articles are processed. Thus, the initial average numbers of a plurality of types of articles are shown in FIG. 9.

[Fourth Embodiment]

The electronic cash register system according to the third embodiment has substantially the same structure as that of the second embodiment. The difference is in that an article setting memory 13 stores a plurality sets of initial average numbers of sold articles. Thus, this structure will be mainly described.

FIG. 10 is an illustration showing a table in the article setting memory 13. The article setting memory 13 stores various article names 101 and correspondingly stores two sets (tables) of the initial average numbers of articles for weekday and holiday for prediction. The CPU 1 selects one of the sets in accordance with the date signal from the clock circuit 12 or operation by the operator through the electronic cash register 23.

In the above-mentioned third embodiment, it is necessary to change the average numbers of articles for initial stage at the beginning of the selling between weekdays and holidays. On the other hand, in the fourth embodiment, two sets of the average numbers of articles for weekdays and holiday are previously set. So, inputting the average numbers of articles can be omitted once they have been inputted.

FIG. 11 depicts a partial flow chart of processing in the kitchen video controller 20A, wherein the step 51 in FIG. 4 is replaced with steps 111 to 113.

Steps 41 to 49 shown in FIG. 4 are executed similarly to the first embodiment. In step 49, if the answer is NO, that is, it is at the initial stage, processing proceeds to step 111. In step 111, the CPU 1 judges whether today is a weekday. If today is weekday (YES), processing proceeds to step 112, and the CPU 1 reads one set of the initial average numbers of articles for weekdays. Next, the CPU 1 predicts the numbers of articles to be prepared through the prediction engine in step 52 similarly to the first embodiment.

In step 111 if today is holiday, (YES), processing proceeds to step 113, and the CPU 1 reads one set of the average numbers of articles for holidays. Next, the CPU 1 predicts the numbers of articles to be prepared through the prediction engine in step 52 similarly to the first embodiment.

In this example, there are two sets of the numbers of articles for weekdays and holidays. However, it is possible to provide more than two sets (tables) of the numbers of articles and these sets may be selected in accordance with season and combination of season and weekday/holiday.

Moreover, for example, for a special weekday such as a Friday, which may show a special selling tendency, another table storing a set of the initial average numbers of articles may be provided.

As mentioned above, in the kitchen video controller 20A according to the fourth embodiment, a plurality of tables storing sets of the averaged numbers of articles and these tables are selected in accordance with weekday/holiday or season. Prediction is repeatedly made if a plurality of types of articles are processed. Thus, the initial average numbers of a plurality of types of articles are shown in FIG. 10.

[Fifth Embodiment]

The electronic cash register system according to the fifth embodiment has substantially the same structure as that of the second embodiment. The difference is in that an article setting memory 13 stores a set of maximum numbers of production articles. Thus, this structure will be mainly described.

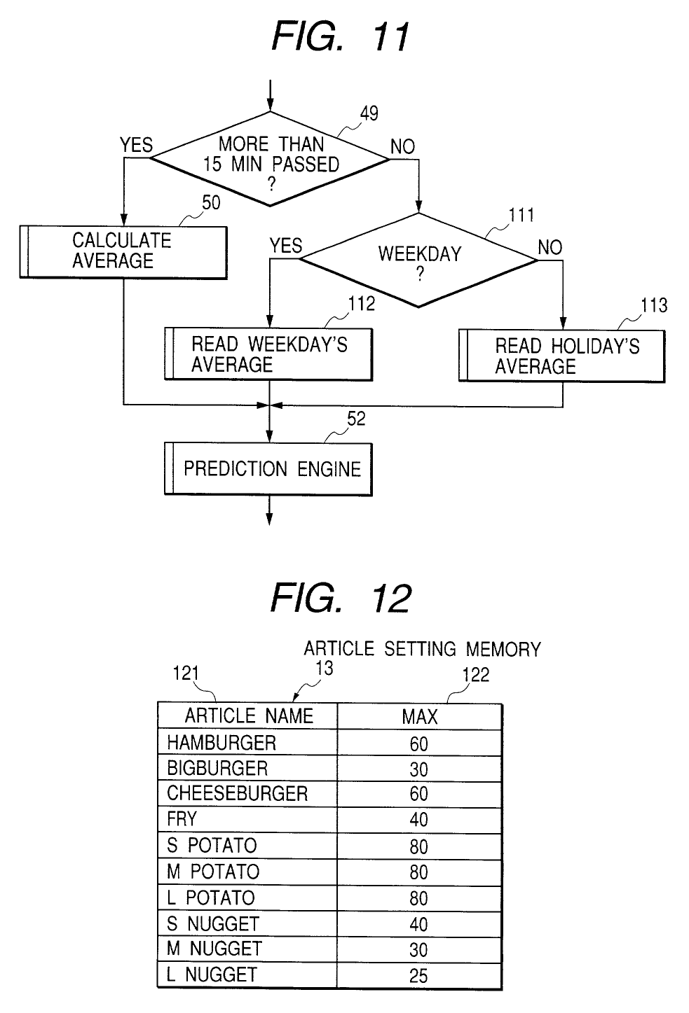

FIG. 12 is an illustration showing a table in the article setting memory 13 according to the fifth embodiment. The article setting memory 13 stores various article names 121 and correspondingly stores maximum numbers 122 of articles which can be produced per unit interval in the shop.

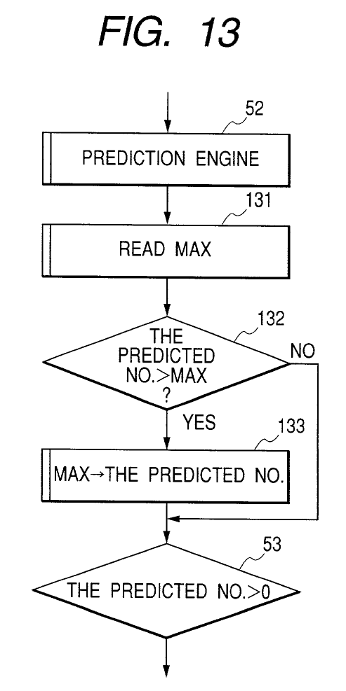

FIG. 13 depicts a partial flow chart of processing in the kitchen video controller 20A according to the fifth embodiment, wherein the steps 131 to 133 are inserted between steps 52 and 53 in the flow chart shown in FIG. 4.

After step 52, the CPU 1 reads the table storing the maximum numbers of articles from the article setting memory 13 in step 131. In the following step 132, the CPU 1 judges whether predicted numbers of articles to be produced are equal to or higher the maximum production number of the articles, respectively. If each predicted number of each type of articles to be produced is equal to or higher than each maximum number of articles, the CPU 1 replaces the predicted number of articles with the corresponding maximum number of articles, and processing proceeds to step 53. In step 53 and the following steps, the CPU 1 executes processing similarly to the second embodiment. This operation is repeated for each type of articles, so that the maximum numbers are stored in the table shown in FIG. 12.

As mentioned above, in the kitchen video controller 20A, the maximum production number setting table is provided. So, though the predicted number of articles exceeds the maximum production number of articles, the maximum production number of articles is indicated. This indication does not disturb the cooks in the kitchen.

[Sixth Embodiment]

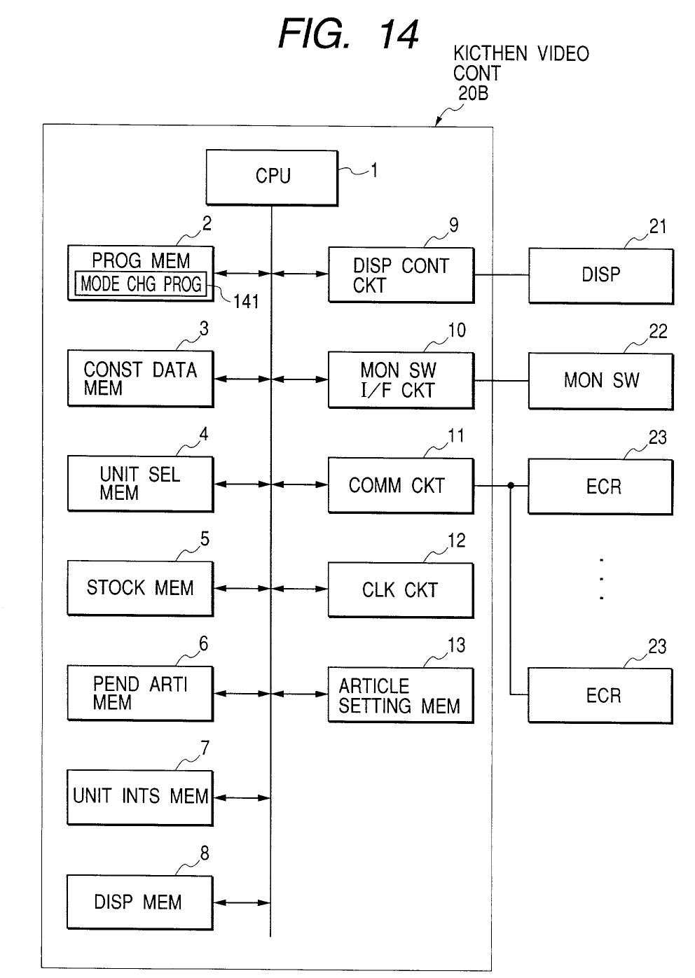

FIG. 14 is a block diagram of an electronic cash register system according to the sixth embodiment. The electronic cash register system according to the sixth embodiment has substantially the same structure as that of the first embodiment. The difference is in that the CPU 1 includes a mode changing means. In fact, the program memory 2 stores a mode changing program 141.

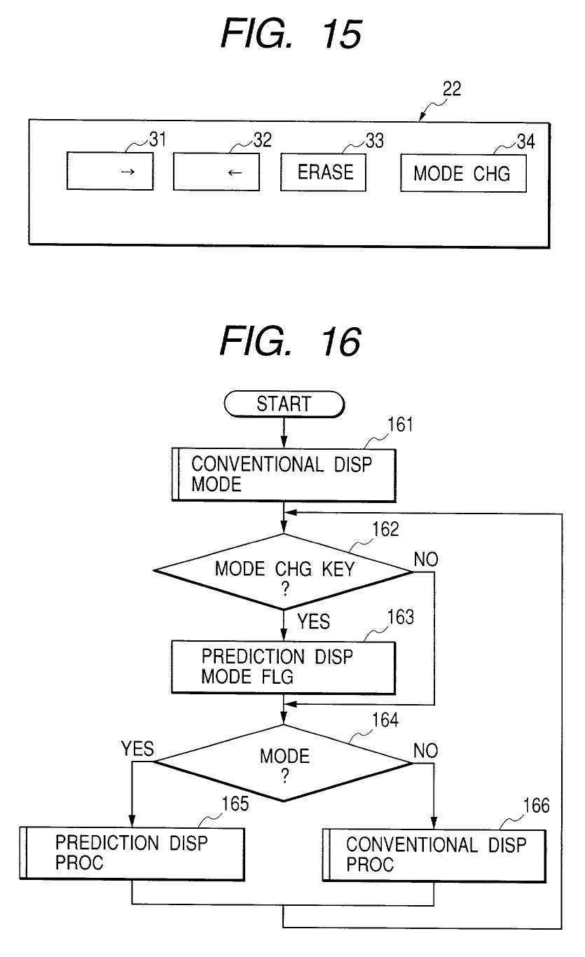

FIG. 15 is a plan view of the monitor switch 22 according to the sixth embodiment. The monitor switch 22 includes the scroll key 31 for shifting the cursor on the display 21 in the right direction, the scroll key 32 for shifting the cursor on the display in the left direction, the erase switch 33 for erasing the display of articles on the display 21 indicted by the cursor, and a mode changing key 34.

In the first embodiment, prediction of the number of articles to be prepared is made in a peak condition and a slow condition. On the other hand, in the sixth embodiment, the CPU 1 changes the operation mode of the kitchen video controller in response to the mode changing key 34 using the mode changing program. When it is in a slow condition, the operator operates the mode changing key 34 to change the preparing method such that the cook prepares the articles on receipt of the order.

FIG. 16 depicts a flow chart showing a mode changing operation according to the sixth embodiment. When at start of selling, the CPU 1 of the kitchen video controller 20B sets the mode to the conventional display mode in step 161. In the following step 162 the CPU 1 checks whether the mode changing key 34 is depressed. If the mode changing key 34 is depressed (mode switching signal is generated), processing proceeds to step 163 to set a prediction display mode flag, and processing proceeds to step 164. If the mode changing key 34 is not depressed, processing directly proceeds to step 164. In step 164, the CPU 1 judges whether the prediction display mode flag has been set.

If the prediction display mode flag has been set, the CPU 1 effects the prediction displaying mode in step 165. If the prediction display mode flag remains reset, the CPU 1 effects the conventional display mode in step 166. After process in steps 165 and 166, processing returns to step 162.

In step 165, the CPU 1 predicts the number of articles to be prepared in the same way as the embodiments mentioned above and displays the predicted number of articles on the display 21. In step 166, the CPU 1 displays the orders from electronic cash registers as they are.

As mentioned above, in the kitchen video controller 20B according to the six embodiment, the display mode for providing the target of preparing the article can be changed in accordance with the condition of the shop or time or date, so that a loss in preparing the articles can be reduced.

[Seventh Embodiment]

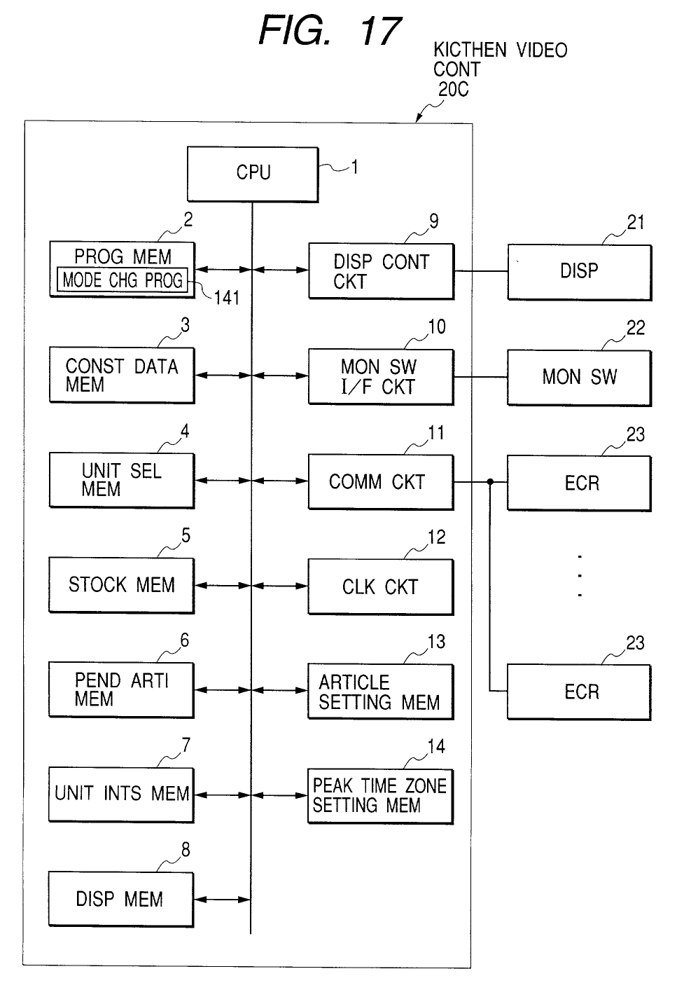

FIG. 17 is a block diagram of an electronic cash register system according to the seventh embodiment. The electronic cash register system according to the seventh embodiment has substantially the same structure as that of the sixth embodiment. The difference is in that the kitchen video CPU 1 further includes a peak time setting memory 14. Because other structure is the same as that of the sixth embodiment, this point will be described mainly.

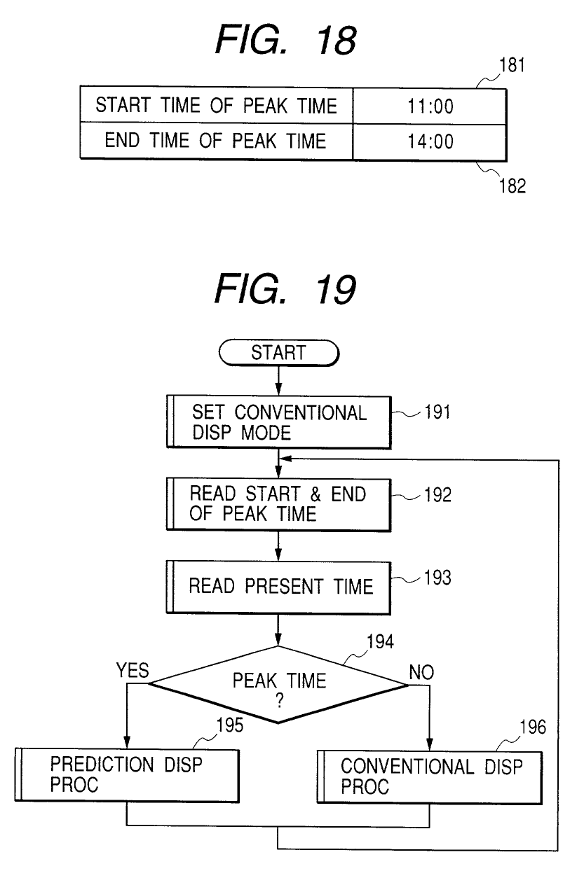

FIG. 18 is an illustration of a table in the peak time setting memory 14. That is, the peak time setting memory 14 stores a start time of peak time (11:00) 181 and the end time of peak time (14:00) 182.

In the sixth embodiment, changing the display mode between the peak time and the slow time with the mode change key 34 on the monitor switch 22. On the other hand, in the seventh embodiment, the mode switching program 141 changes the display mode in accordance with the start time and the end time of the peak time and the clock circuit 12.

FIG. 19 depicts a flow chart showing a mode changing operation according to the seventh embodiment. When at start of selling, the CPU 1 of the kitchen video controller 20C sets the mode to the conventional display mode in step 191. In the following step 192, the CPU 1 reads the start time of the peak time 181 and the end time of the peak time 182 (peak time zone). In the following step 193, the CPU 1 reads the present time 193 from the clock circuit 12. Next, the CPU 1 judges whether the present time is at the peak time by comparing the start time and the end time of the peak time. More specifically, the CPU 1 checks whether the present time is after the start time and before the end time of the peak time.

If the present time is at the peak time zone, processing proceeds to step 195 (the mode switching signal is generated) and if the present time is not at the peak time, processing proceeds to step 196.

In the step 195, the CPU 1 executes the prediction display process. In step 196, the CPU 1 executes the conventional display process. After processing in step 195 and 196, processing returns to step 192.

As mentioned above, in the kitchen video controller 20C according to the seventh embodiment, the mode changing program 141 changes the display mode in accordance with the peak time data stored in the peak time setting memory 14. Thus, when the selling condition of the shop is slow, the display indicates the articles to be prepared in accordance with received orders and when the selling condition is at peak, the display indicates the number of articles to be prepared through prediction. Thus, the display mode is automatically changed, so that the operation is made more convenient.

[Eighth Embodiment]

The electronic cash register system according to the eighth embodiment has substantially the same structure as that of the sixth embodiment. The difference is in that a rotary switch 200 is connected to the monitor switch interface circuit 10 instead the monitor switch 22.

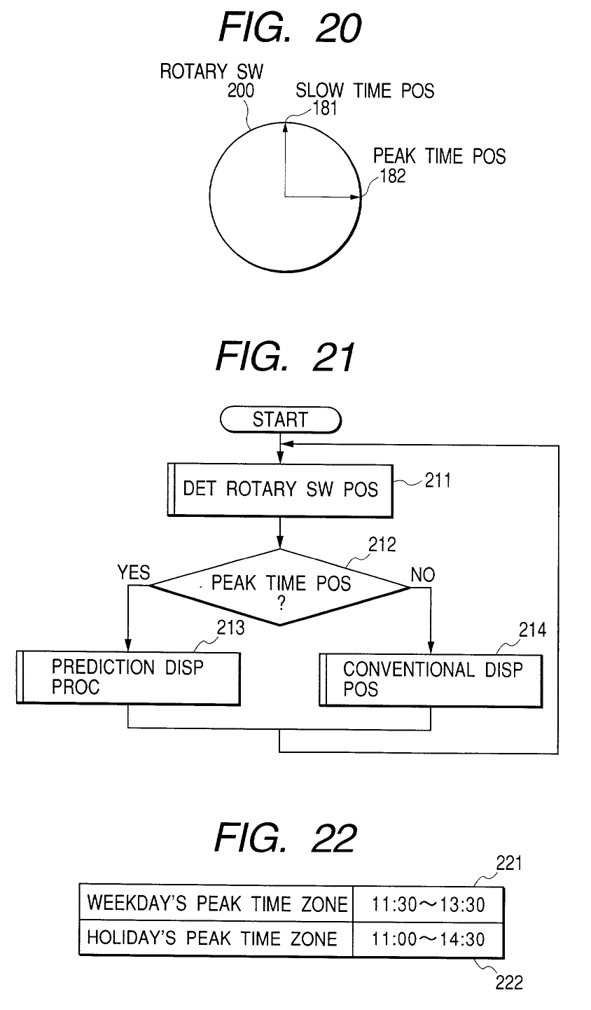

FIG. 20 is an illustration of the rotary switch 200. The rotary switch 200 has a slow condition position 181 and a peak time condition position 182.

In the sixth embodiment, the mode change key 34 on the monitor switch 22 effects the switching between the peak condition and the slow condition. On the other hand, in the kitchen video controller according to the eighth embodiment, the rotary switch 200 provides the mode change (generates the mode switching signal).

FIG. 21 depicts a flow chart of the display mode changing operation according to the eighth embodiment.

In step 211, the CPU 1 detects the position of the rotary switch 200. Next, the CPU 1 judges whether the rotary switch 200 is at the peak time position. If the position of the rotary switch 200 is at the peak time position, processing proceeds to step 213 and if the position of the rotary switch 200 is at the slow position, processing proceeds to step 214.

In step 213, the CPU 1 executes the prediction display processing, that is the CPU 1 predicts the number of the articles to be prepared and displays the predicted number of the article. In step 214 the CPU 1 executes the conventional display position 214, that is, the CPU 1 display the received order without prediction. After process in step 213 or step 214, processing returns to step 211.

As mentioned above, the kitchen video controller 20C according to the eighth embodiment, the display mode is switched in response to the signal from the rotary switch 200. Thus, the display mode switching is made in accordance with the operator, so that adaptive display mode is provided. Moreover, the positions of the rotary switch 200 for the peak time and the off time can be secret from other operator. Thus, security can be improved. Moreover, the rotary switch may include a key mechanism. In this case, only the operator having the key can change the display mode. Thus, erroneous switching can be prevented.

[Ninth Embodiment]

The electronic cash register system according to the ninth embodiment has substantially the same structure as that of the seventh embodiment shown in FIG. 17. The difference is in that the peak time zone setting memory 14 stores a plurality of sets of peak time zones.

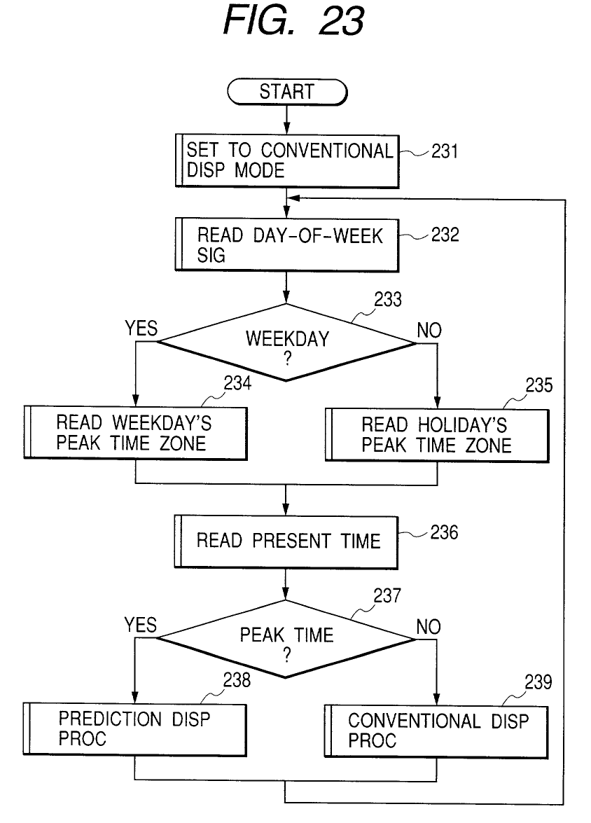

FIG. 22 is an illustration showing a table in the peak time zone setting memory 14. The peak time zone setting memory 14 stores a weekday's peak time zone (11:30-13:30) 221 and a holiday's peak time zone (11:00-14:00) 222. The CPU 1 of the kitchen video controller 20C selects one of the peak time zones with reference to the clock circuit 12. Thus, the display mode can be changed in accordance with the peak time zone which varies with the day of a week.

FIG. 23 depicts a flow chart of display mode changing operation according to the ninth embodiment.

When at start of selling, the CPU 1 sets the mode to the conventional display mode in step 231. In the following step 232 the CPU 1 reads the day-of-week signal from the clock circuit 12. Next, the CPU 1 judges whether today is a weekday in step 233. If today is a weekday (YES), the CPU 1 reads the weekday's peak time zone from the peak time zone setting memory 14. If today is a holiday (NO), the CPU 1 reads the holiday's peak time zone from the peak time zone setting memory 14.

After process in step 234 or 235, the CPU 1 reads the present time in step 236. Next, the CPU judges whether the present time is at the peak time zone by comparing the start time and the end time of the peak time zone. More specifically, the CPU 1 checks whether the present time is after the start time and before the end time of the peak time zone.

If the present time is at the peak time zone, processing proceeds to step 238 and if the present time is not at the peak time, processing proceeds to step 239.

In the step 238, the CPU 1 executes the prediction display process. In step 239, the CPU 1 executes the conventional display process. After process in step 238 or 239, processing returns to step 232.

As mentioned above, in the kitchen video controller 20C according to the ninth embodiment, the mode changing program changes the display mode in accordance with the peak time data stored in the peak time zone setting memory 14. Thus, when the selling condition of the shop is slow, the display indicates the articles to be prepared in accordance with received orders and when the selling condition is at peak, the display indicates the number of articles to be prepared through prediction. Moreover, the display mode is changed in accordance with the day of a week or a special sale day, so that the display mode is automatically changed. Accordingly, the operation is made more convenient.

[Tenth Embodiment]

The electronic cash register system according to the tenth embodiment has substantially the same structure as that of the seventh embodiment shown in FIG. 17. The difference is in that switching the display mode is commanded from an electronic cash register 23.

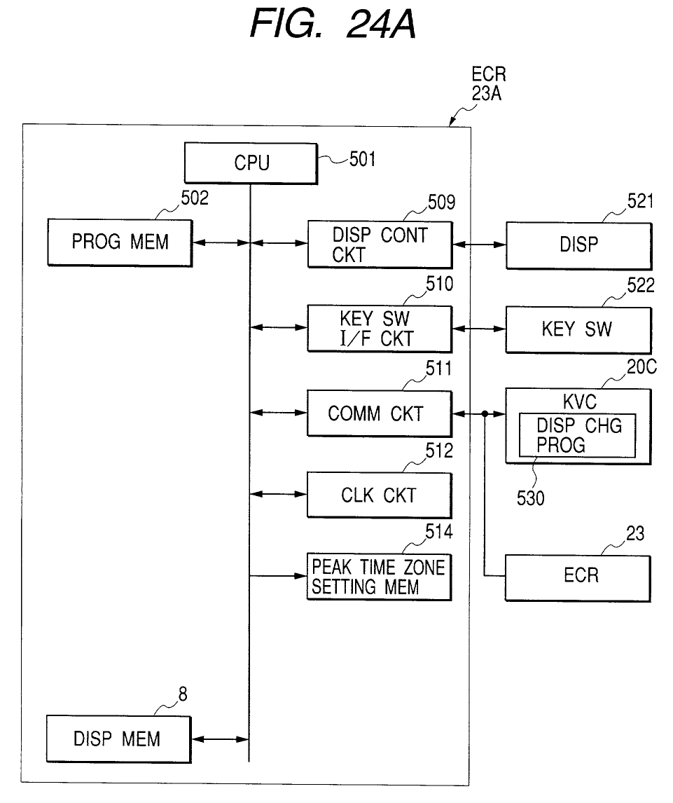

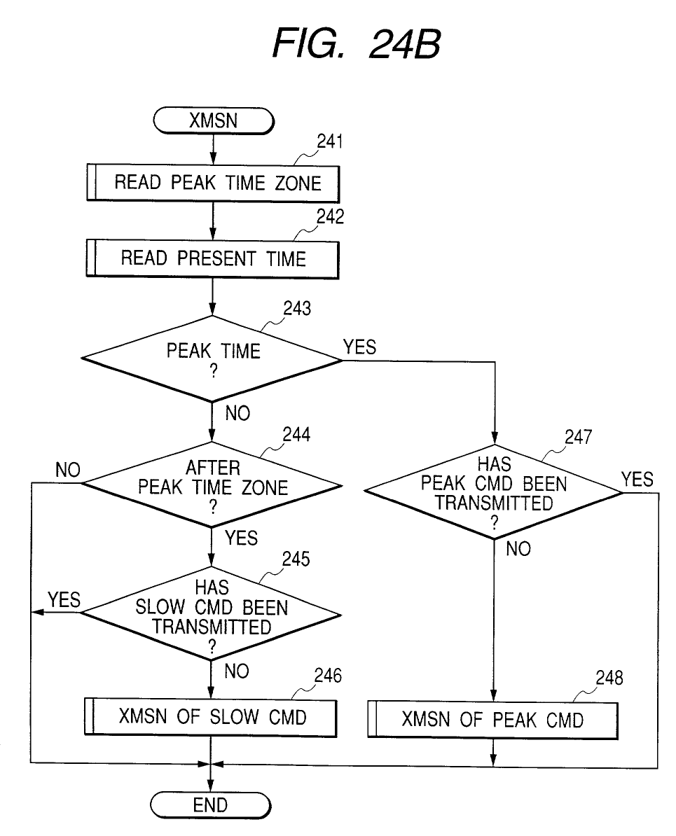

FIG. 24A is a block diagram of an electronic cash register 23A.

The electronic cash register 23 includes a CPU 501, a program memory 502, a display control circuit 509, a key switch interface circuit 510, a communication circuit 511 for communicating with the kitchen video controller 20, a clock circuit 512 for generating a time signal including time data, date data, and day-of-week data, and a peak time zone setting memory 514.

The CPU 501 effects order reception process and accounting process in response to the key switches operated by an operation. The order data is sent to the video kitchen controller 20C as mentioned above. In addition, the electronic cash register 23A transmits a peak command indicating that it is within the peak time zone or a slow command indicating that is within the slow time zone to the video kitchen controller 20. On the other hand, the kitchen video controller 20C includes a display switching program 530 for switching the display mode between the conventional display mode and the prediction display mode in response to the peak and slow commands from the electronic cash register 23A.

FIG. 24B depicts a flow chart of display mode switching operation from an electronic cash register 23 according to the tenth embodiment.

The CPU 501 in the electronic cash register 23A reads the peak time zone (data) from the peak time zone setting memory 514 storing the peak time zone as shown in FIG. 18 or 22.

In the following step 242, the CPU 501 reads the present time from the clock circuit 512. Next, the CPU 501 judges whether the present time is at the peak time by comparing the start time and the end time of the peak time zone data. More specifically, the CPU 501 checks whether the present time is after the start time and before the end time of the peak time.

If the present time is within the peak time zone, processing proceeds to step 247. If the present time is not within the peak time zone, processing proceeds to step 244.

In the step 244, the CPU 501 judges whether the present time is after the peak time zone of today. If the present time is not after the peak time zone, processing ends. If the present time is after the peak time zone, the CPU 501 judges whether the slow command has been transmitted. If the slow command has been transmitted, processing ends. If the slow command has not been transmitted instep 245, the CPU 1 transmits the slow command to the video kitchen controller 20 in step 246.

In step 247, the CPU 510 judges whether the peak command has been transmitted. If the peak command has been transmitted, processing ends. If the peak command has not been transmitted, the CPU 501 transmits the peak command to the video kitchen controller 20 in step 248.

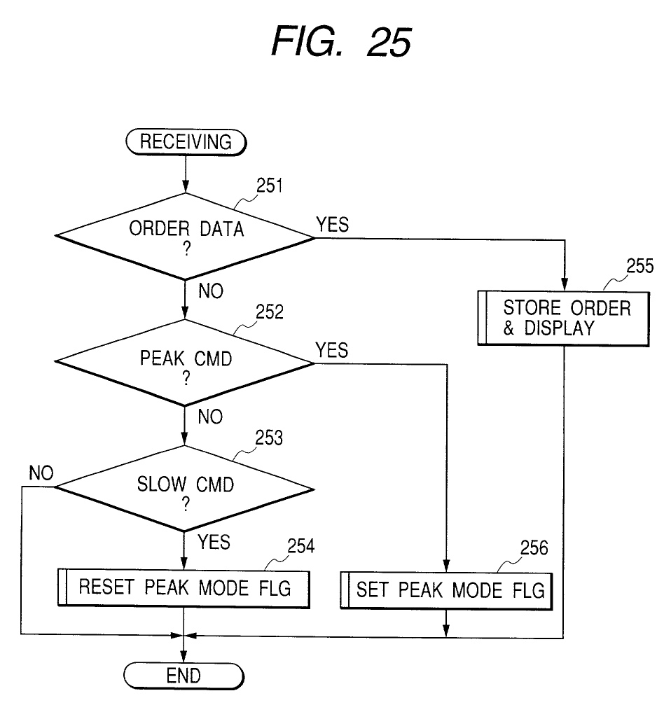

FIG. 25 depicts a flow chart of receiving commands from the electronic cash register 23 by the video controller 20C.

In step 251, the CPU 1 judges whether the command received from an electronic cash register is article data (order data). If the data is article data, processing proceeds to step 255. If the command is data other than the article data, processing proceeds to step 252.

In step 252, the CPU 1 judges whether the received command is the peak command. If the received command is the peak command, processing proceeds to step 256 and if the received command is other than the peak command, processing proceeds to step 253.

In step 253, the CPU 1 judges whether the received command is the slow command. If the received command is the slow command, processing proceeds to step 254. If the received command is other than the slow command, processing ends.

In step 254, the CPU 1 resets the peak mode flag with the mode switching program 141 to enter the conventional display mode, and processing ends.

In step 256, the CPU 1 sets the peak mode flag to enter the prediction display mode (generates the mode switching signal) and processing ends.

In step 255, the CPU 1 stores the article data (order data) for the display operation.

As mentioned above, the electronic cash register can send the peak command to the kitchen video controller 20C with the clock circuit, the peak time zone data stored therein, and the communication circuit 511. On the other hand, the video kitchen controller 20C receives the peak (/slow) command from an electronic cash register 23A and in response to the peak command, the video kitchen controller 20C sets or resets the peak mode flag. If the peak mode flag has been set, the kitchen video controller 20C provides the prediction display mode. If the peak mode flag has been reset (slow command has been set), the kitchen video controller 20C provides the conventional display mode for simply displaying the ordered articles. Thus, the operator can switch the display mode of the kitchen video controller which is slightly remote from the electronic cash register. Moreover, one electronic cash register coupled to a plurality of kitchen video controller 20C can change the display mode of a plurality of kitchen video controllers 20C at the same time. In this case, the addresses of both kitchen video controllers may be registered in the electronic cash register, or the electronic cash register may have the multiple addressing function. Thus, the changing display mode is effected in a plurality of kitchen video controller synchronously.

[Eleventh Embodiment]

The electronic cash register system according to the eleventh embodiment has substantially the same structure as that of the seventh embodiment shown in FIG. 17. The difference is in that the kitchen video controller 20D further concludes a historic memory 15 for storing historic data of orders, time or date data, and production data, and a recording device 16.

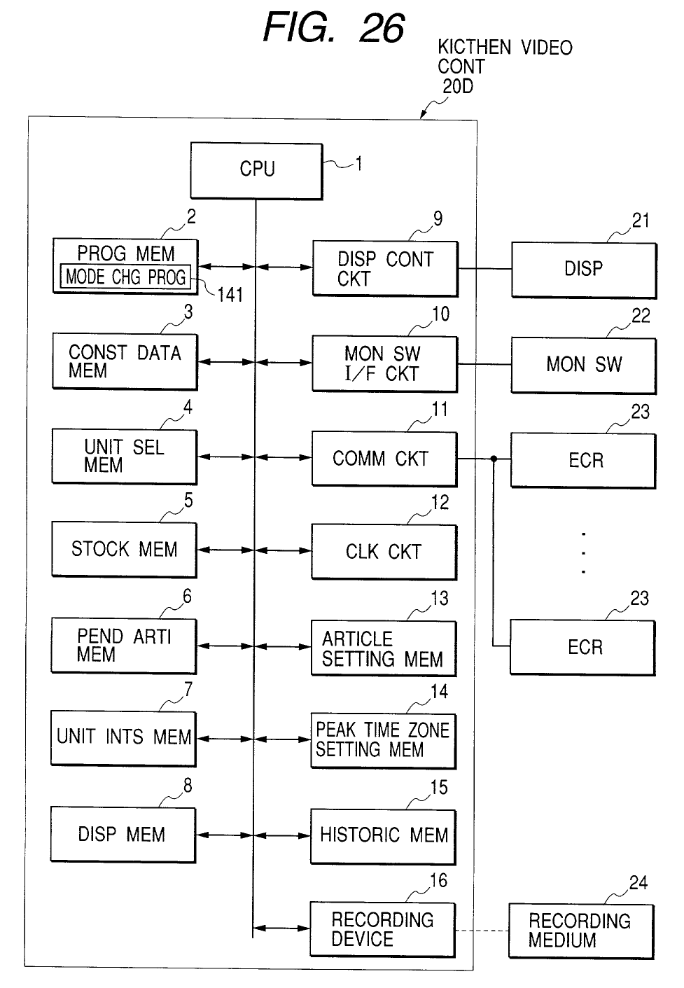

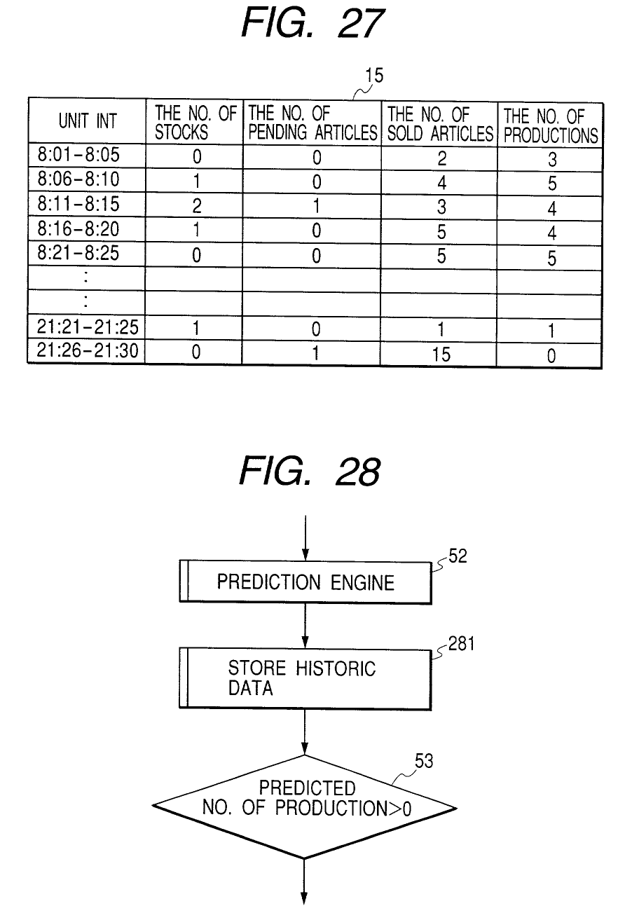

FIG. 26 is an electronic cash register system according to the eleventh embodiment, and FIG. 27 is a table storing the historic data according to the eleventh embodiment.

The historic memory 15 stores data of the number of stock articles, the number of pending articles, the number of actually sold articles, and the number of ordered productions with relation to time zones as shown in FIG. 27 for unit interval from opening at 8:01 to closing at 21:30. The historic data for prediction is further stored in a recording medium 24 such as a floppy disc and an IC card memory with the recording device 16. The recording medium can be used in the other terminals.

FIG. 28 depicts a partial flow chart of display operation. Processing up to step 52 is the same as that shown in FIG. 4. In the following step 281, the CPU 1 of the kitchen video controller 20D stores the historic data in the historic memory 15 and the recording medium 24 at every unit interval. Next processing proceeds to step 53 which has been described at the first embodiment.

As mentioned above, the kitchen video controller stored the historic data in the historic memory 15 and in the recording medium 24, so that data processing in other terminals is provided. The historic data for prediction in the recording medium 24 provides analysis of the error between the prediction and the actual sold articles. Thus, the accuracy of the prediction engine can be improved.

[Twelfth Embodiment]

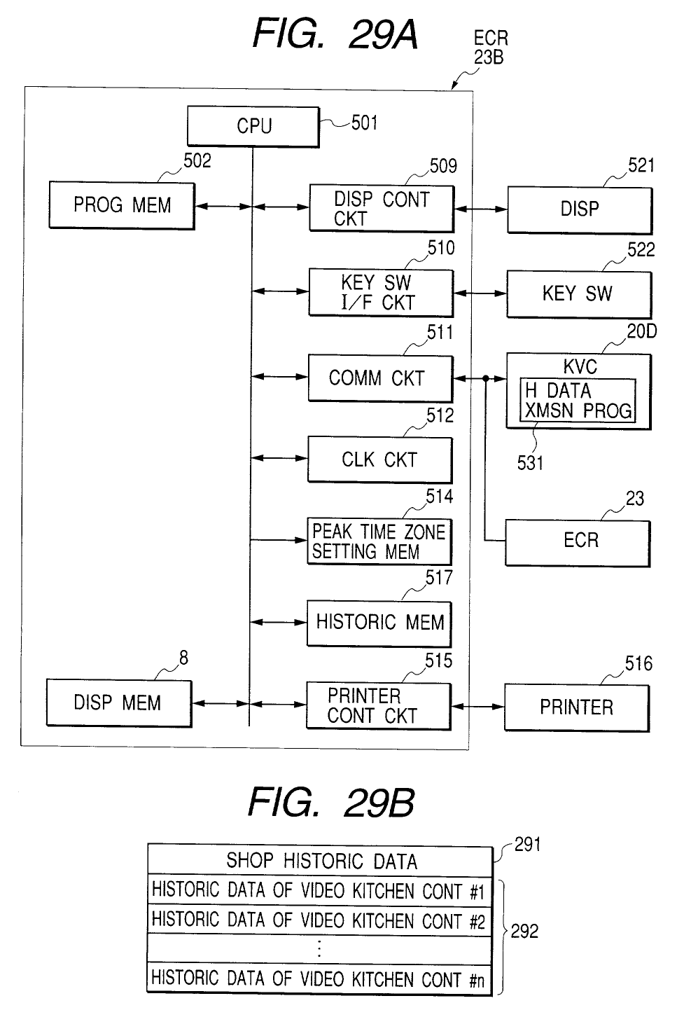

The electronic cash register system according to the twelfth embodiment has substantially the same structure as that of the eleventh embodiment shown in FIG. 26. The difference is in that the kitchen video controller 20D can transmits the historic data stored in the historic memory 15 to the electronic cash register and the electronic cash register can receives the historic data from the kitchen video controller. Moreover, the electronic cash register can print the historic data with a printer 516 and printer control circuit 515 shown in FIG. 29A which is a block diagram of the electronic cash register 23B according to the twelfth embodiment.

In the eleventh embodiment, the historic data is stored in the recording medium with the recording device 16. On the other hand, in this embodiment, the kitchen video controller 20D can transmit the historic data including shop historic data to an electronic cash register 23B coupled to the kitchen video controller 20D through the communication circuit 11. The electronic cash register 23B receives the historic data and stores the historic data in the historic memory 517.

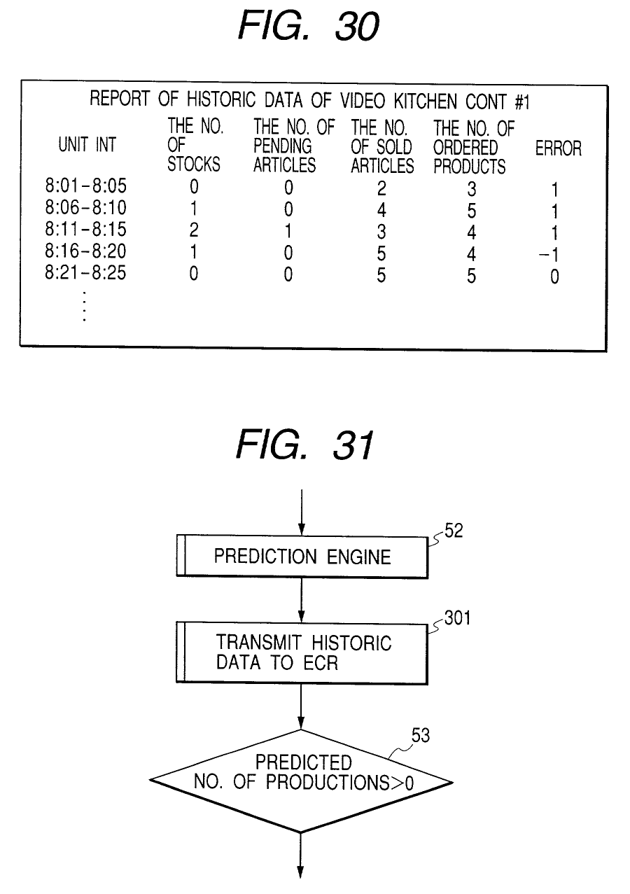

The received (transmitted) historic data includes historic 291 data of the whole of the shop and historic data 292 of respective kitchen video controllers #1 to #n as shown in FIG. 29B. Thus, the electronic cash register 23B can process the historic data in the shop and can print the historic data with printer 516 as shown in FIG. 30.

FIG. 31 depicts a partial flow chart showing transmission operation in the display operation.

The processing up to step 52 is the same as that of the first embodiment shown in FIG. 4. In the following step 301, the CPU 1 transmits the historic data including the time of the unit interval, the number of stocked articles, the number of pending articles, the number of actual sold articles, and the number of ordered articles (productions) to the electronic cash register. After processing in step 301, the CPU 1 executes processing after 53 in the same manner as the first embodiment.

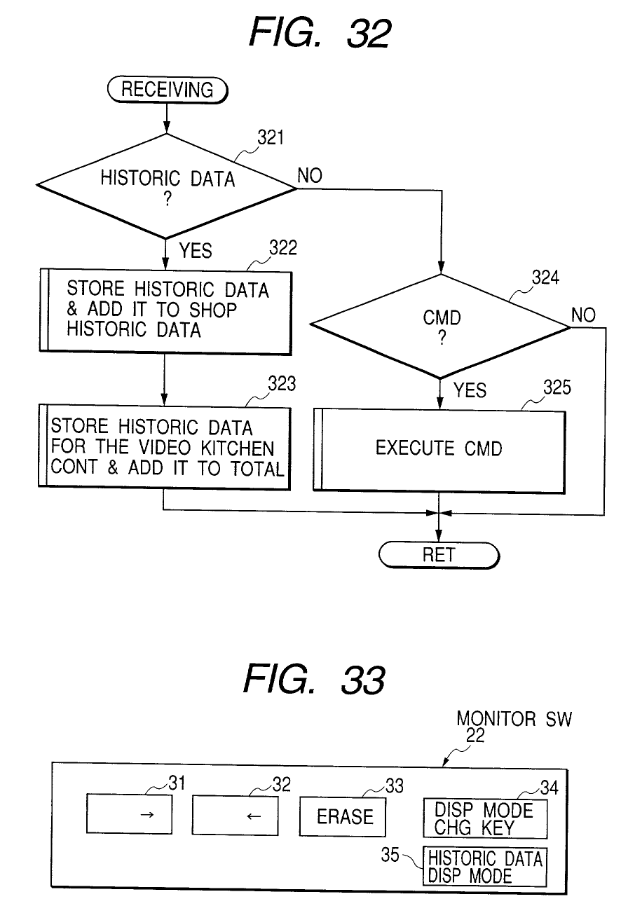

FIG. 32 depicts a flow chart of receiving operation of the historic data according to the twelfth embodiment.

When the CPU 501 in the electronic cash register 23B receives a request of receiving, the CPU 501 judges whether the received data is historic data in step 321. If the received data is historic data, processing proceeds to step 322. If the received data is not the historic data, processing proceeds to step 324.

In step 322, the CPU 501 stores the historic data and adds it to the shop historic data. In the following step 323, the CPU 501 stores the historic data for the video kitchen controller 20D in the historic memory 517 and processing returns to the main routine of the electronic cash register 23B.

In step 324, the CPU 501 judges whether the data is a command. If the data is a command, the CPU 501 executes a predetermined command operation in accordance with the received command instep 525. If the data is other than commands, processing returns to the main routine of the electronic cash register 23B.

Transmission of the historic data is executed at every unit interval. However, transmission may be effected at every reception of the order. In this case, the counts of the stocks, the pending orders, the actual sold articles, and the productions are accumulated in the cash register 23B also.

As mentioned above, the kitchen video controller 20D according to the twelfth embodiment transits the historic data for prediction to the electronic cash register 20B. The electronic cash register 23B provides the report of the historic data including the number of stocks, pending ordered articles, actually sold articles, and products for the whole of the shop and for respective kitchen video controllers. Thus, the operator can analyze the error between the predicted number of articles and the actually sold articles at a real time manner without stopping the kitchen video controller's operation and without addition of any special equipment. Thus, this improves the prediction accuracy. Moreover, if a plurality of kitchen video controller is provided and coupled to electronic cash registers, the historic data of the whole of the shop can be collected.

[Thirttenth Embodiment]

The electronic cash register system according to the thirteenth embodiment has substantially the same structure as that of the eleventh embodiment shown in FIG. 26. The difference is in that the display 21 displays the number of stocks, the number of pending orders (articles), and the number of the predicted number of productions.

In the eleventh embodiment, the historic data stored in the historic memory 15 is outputted to the external recording medium. In the thirteenth embodiment, the historic data is displayed on the display 21 coupled to the kitchen video controller to make the operator easily confirm the result of the prediction.

FIG. 33 is a plan view of the monitor switch 22 according to the thirteenth embodiment. The monitor switch 22 includes the scroll key 31 for shifting the cursor in the right direction, the scroll key 32 for shifting the cursor on the display 21 in the left direction, the erase key 33 for erasing the article indicated by the cursor, a display mode changing key 34 for changing the display mode between the conventional mode and the prediction display mode, and a historic data display mode key 35.

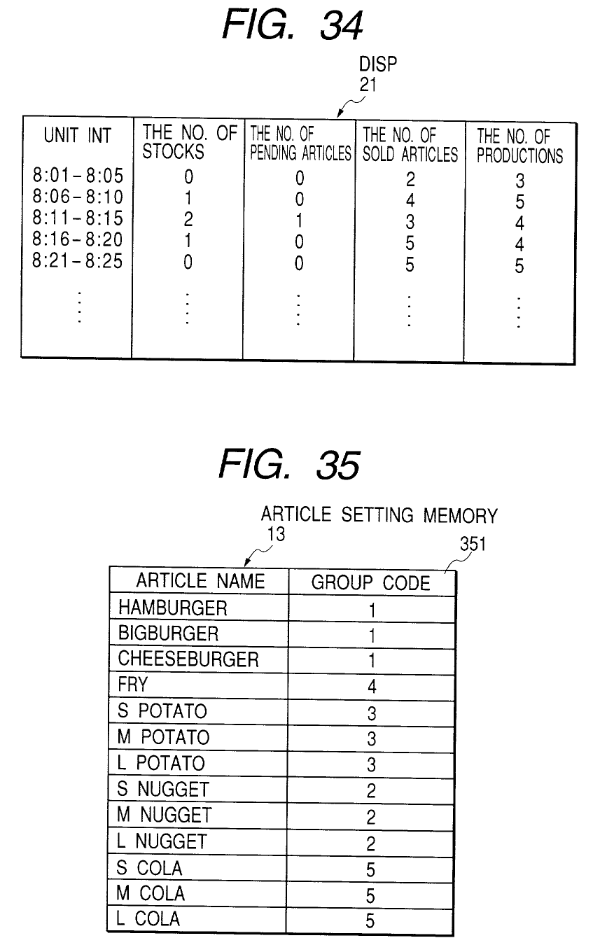

FIG. 34 is an illustration of the screen of the display 21 according to the thirteenth embodiment.

The CPU 1 displays the historic data from the historic memory 15 in response to the historic data display mode key 35.

As mentioned above, the kitchen video controller according to the thirteenth embodiment includes the historic data display mode key 35 to display the historic data on the display 21. So, the operator (cook) can know the difference (error) between the predicted number of article to be prepared and the number of the actually sold articles. Thus, the operator can improve the accuracy in the prediction engine.

[Fourteenth Embodiment]

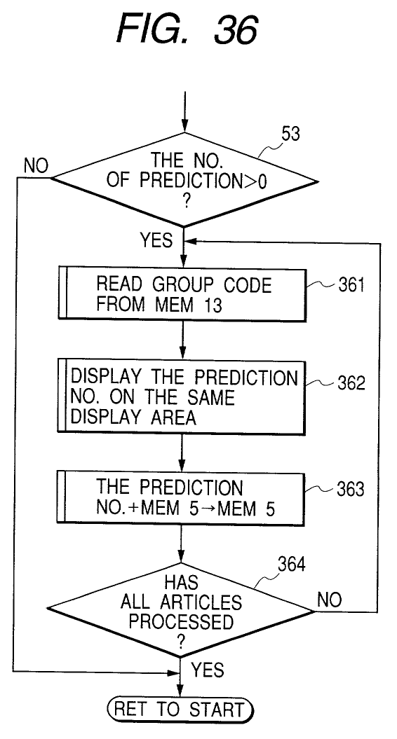

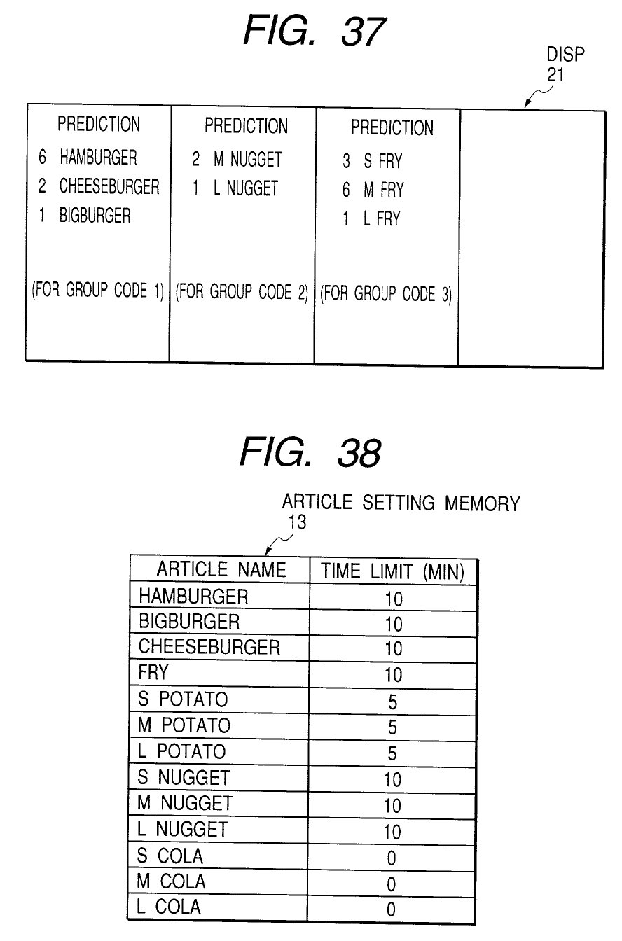

The electronic cash register system according to the fourteenth embodiment has substantially the same structure as that of the eleventh embodiment shown in FIG. 26. The difference is in that the article setting memory 13 correspondingly stores the article names 13 and group codes 351 as group setting table. FIG. 35 shows the group setting table according to the fourteenth embodiment. FIG. 37 is an illustration of display screen of the display 21.

The CPU 1 can change the display image to the display image shown in FIG. 37. That is, the articles names having the same group code are displayed with the prediction numbers of them in the same display area. Thus, articles having the difference group codes are displayed on the different area in the screen as shown in FIG. 37.

In the former embodiments, the articles are displayed in order as shown in FIG. 5. On the other hand, in this embodiment, each of articles is provided with a group code. Thus, articles are displayed at every group display area. So, the articles which are prepared in the same manner are displayed together. Therefore, the production efficiency can be improved.

FIG. 36 depicts a partial flow chart of display operation according to the fourteenth embodiment.

Processing up to step 53 is the same as processing in the first embodiment shown in FIG. 4. In step 53, the CPU 1 judges whether the prediction number of production is higher than zero. If the prediction number of production is higher than zero, processing proceeds to step 361. If the prediction number of production is not higher than zero, processing returns to step 41 in FIG. 4.

In step 361, the CPU 1 reads the group codes from the article setting memory 13. In the following step 362, the CPU 1 displays the article names and the predicted number of articles to be prepared at every group code area as shown in FIG. 37. In the following step 363, the CPU 1 adds the prediction number of articles to the number of stocks to store the result in the stock memory 5. In step 364, the CPU 1 judges whether all articles have been displayed. If all articles have not been displayed processing returns to step 361. If all articles have been displayed, processing returns to step 41 in FIG. 4.

As mentioned above, the kitchen video controller according to the fifteenth embodiment displays the predicted number of articles to be prepared at every group area. For example, different types of articles but commonly using the same material such as meet, potato are displayed together in the same group areas on the display 21. Thus, it is unnecessary that the cook searches the article name and the predicted number on the display. Moreover, this eliminates oversight. Thus, the efficiency in production can be improved.

[Fifteenth Embodiment]

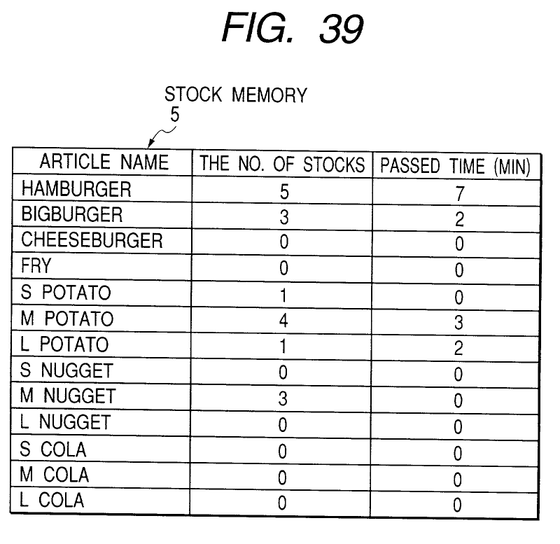

The electronic cash register system according to the fifteenth embodiment has substantially the same structure as that of the eleventh embodiment shown in FIG. 26. The difference is in that the article setting memory 13 stores time limit for every article. FIG. 38 is an illustration of time limits respective articles according to the fifteenth embodiment. FIG. 39 is an illustration of passed time of stocked articles.

The article setting memory 13 stores time limits of respective articles. Moreover, the stock memory 5 further stores passed time (minutes) every article name as shown in FIG. 39.

In the former embodiments, the predicted number of articles are added to the number of stocks every type of article and the result is stored. On every selling of an article, the number of stocks of the sold article is decremented. Articles of which passed interval after cooking exceeds the time limit are abandoned because the quality decreases. Thus, the prediction engine stores the passed intervals of the respective articles after cooking. Then, the prediction engine can know the abandon of the articles. Then, the number of abandoned articles is subtracted from the number of the stocked articles. Thus, the prediction accuracy can be improved.

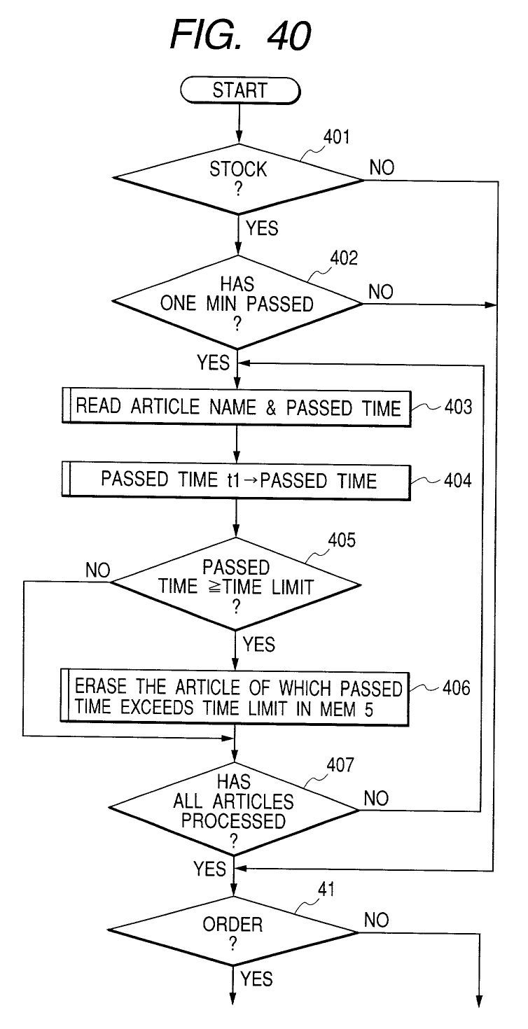

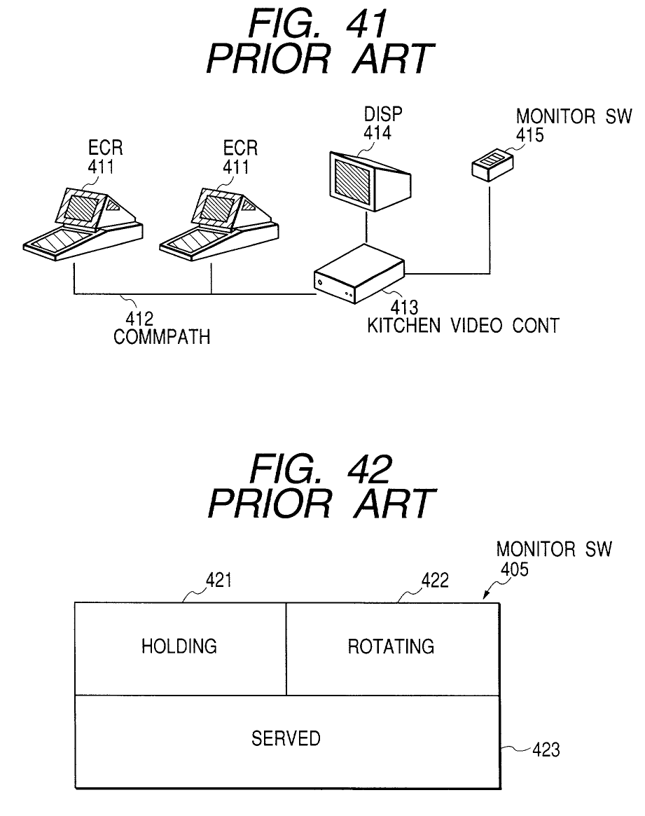

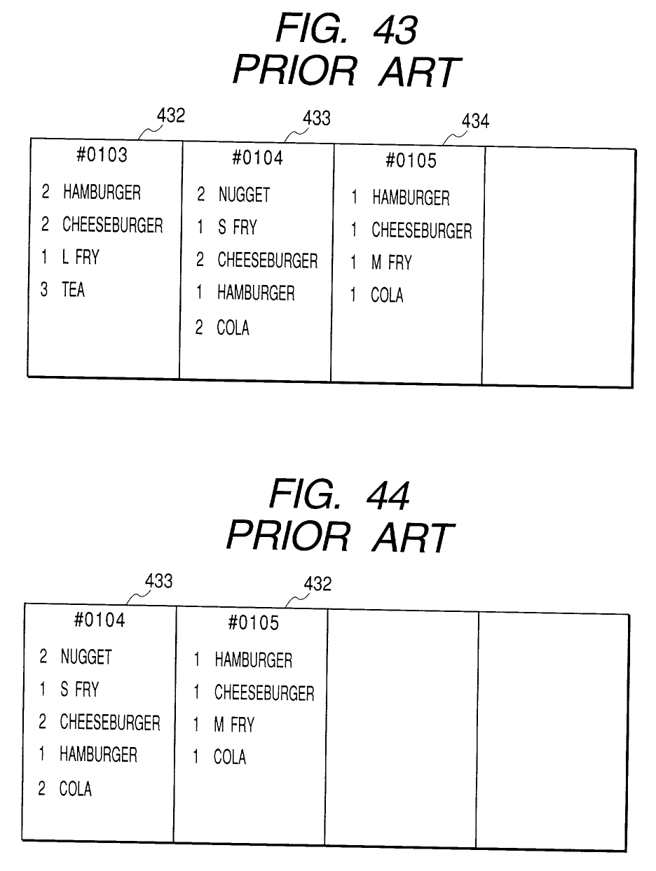

FIG. 40 depicts a flow chart showing abandon operation according to the fifteenth embodiment.

In step 401, the CPU 1 judges whether there is stock. If there is stock, processing proceeds to step 402. If there is no stock processing proceeds to step 407.

In step 402, the CPU 1 judges whether abandon unit interval (one minute) has passed. If one minute has passed, processing proceeds to step 403. If one minute has not passed, processing proceeds to step 407.

In step 403, the CPU 1 reads the articles and their passed intervals from the stock memory 5. In the following step 404, the CPU 1 adds one (minute) to the passed interval(s) of the stock articles. Next, the CPU 1 judges whether each of the passed intervals agree with each of the time limits of the stocked articles. If the passed interval agrees with the time limit of the article, processing proceeds to step 406. If the passed interval does not agrees with the time limit of the article, processing proceeds to step 407.

In step 406, the CPU 1 clears the article of which passed interval agrees with the time limit or decreases the number of the stocked articles by one. The article of which passed interval agrees with the time lime is dumped by the operator or automatically.

In step 407, the CPU 1 judges whether all articles in the stock memory 5 have been processed. If all articles in the stock memory 5 have been processed, processing proceeds to step 41. If NO in step 407, processing returns to step 403.

In step 41, the CPU 1 executes the processing in the first embodiment shown in FIG. 4.

As mentioned above, in the fifteenth embodiment, the prediction is executed by using the number of articles of the remaining stocked articles with the articles of which passed intervals agree with the time limits are dumped. Thus, accuracy in prediction is improved.

As mentioned above, in the electronic cash register according to this invention, the number of articles which will be necessary after a unit interval (a predetermined interval) is predicted from the number of articles sold for the unit interval, the number of stocked articles for the unit interval, the number of pending articles for the unit interval, and the number of articles sold for a plurality of unit intervals. Thus, the production command including the number of articles which will be necessary after a predetermined interval can be provided automatically, which was done by a skilled operator. Thus, the operator having substantially no experience can provide the prediction production command with this system.

Moreover, the prediction displaying is switched between the peak time zone and the slow time zone. Thus, a favorable displaying can be provided.

As mentioned above, the number of each type of articles necessary after a just after interval is predicted from the number of articles sold for just before unit interval, the number of articles stocked for the just before unit interval, the number of articles which is pending for the just before unit interval, and the number of articles sold for a just before interval. The unit interval and the just after interval is shorter than the just before interval. The just after interval may agree with the unit interval in length. The just before interval includes a plurality of the unit interval. In the above mentioned embodiments, the unit interval is five minutes, the just before interval is 15 minutes and the just after interval is five minutes.

What is claimed is:

1. An electronic cash register system comprising:
a display controller having a display and an electronic cash register, said display controller includes:
receiving means for receiving order data from said electronic cash register, said order data including the number of articles;
first means for obtaining the number of articles ordered for a just before unit interval in response to said order data from said receiving means;
second means for obtaining the number of stocked articles for said just before unit interval;
third means for obtaining the number of pending articles to be prepared for said just before unit interval;
fourth means for obtaining the averaged number of articles sold for a just before interval including consecutive just before unit intervals using said first means;
prediction means for predicting the number of articles to be prepared after a predetermined interval in accordance with data from said first to fourth means; and
displaying means for displaying result of said predicted the number on said display.

2. An electronic cash register system as claimed in claim 1, wherein said order data further includes a type of said articles and said display controller further comprises:
specifying means response to an operation by a user for specifying each type of said articles as to whether the number of each type of said articles is predicted by said prediction means.

3. An electronic cash register system as claimed in claim 1, wherein said order data further includes a type of said articles and said display controller further comprises: setting means for setting the tentative number of each type of said articles, which is used by said prediction means until said fourth means can obtain the average number of articles sold for said interval.

4. An electronic cash register system as claimed in claim 3, wherein said display controller further comprises: a plurality of setting means, each for setting the different prospective number of each type of said articles, which is used by said prediction means until said fourth means can obtain the average number of articles sold for said interval, and selecting means for selectively supplying to said fourth means the different prospective number of each type of said articles from one of said setting means selected in accordance with a condition.

5. An electronic cash register system as claimed in claim 1, wherein said display controller further comprises a maximum number setting means for setting and storing the maximum number for said articles, wherein said displaying means displays said result when the number of articles does not exceed said maximum number and displays said maximum number of said articles when said result exceeds said maximum number.

6. An electronic cash register system as claimed in claim 1, wherein said display controller further comprises:
second displaying means for displaying data of articles ordered from said electronic cash register;
mode switching means for switching a first display mode by said display means using said prediction means and a second display mode by said second display means and in response to a display mode switching signal.

7. An electronic cash register system as claimed in claim 6, wherein said display controller further comprises:
setting means for setting a time zone of operating said prediction means;
clock means for generating a time signal representing the present time;
mode switching signal generation means for generating said display mode switching signal when said present time is at said time zone.

8. An electronic cash register system as claimed in claim 6, wherein said display controller further comprises:
mode switching signal generation means for generating said display mode switching signal in response to a rotary switch connected to said video kitchen controller.

9. An electronic cash register system as claimed in claim 6, wherein said display controller further comprises:
setting means for setting a plurality of different time zones;
selecting means for selecting one of said different time zones in response to a selection signal;
clock means for generating a time signal representing the present time; and
mode switching signal generation means for generating said display mode switching signal when said present time is at said selected one of said different time zone.

10. An electronic cash register system as claimed in claim 6, wherein said electronic cash register further comprises:
display mode switching signal generation means for generating a display mode switching signal in response to switching command; and
transmission means for transmitting said display mode switching signal and said display controller further comprises:
receiving means for receiving said display mode switching signal to supply said display mode switching signal to said mode switching means.

11. An electronic cash register system as claimed in claim 1, wherein said display controller further comprises:
historic data storing means for storing said data as historic data; and
outputting means for outputting said historic data in response to an output command.

12. An electronic cash register system as claimed in claim 11, wherein said outputting means includes transmission means for transmitting said historic data in response to said output command, said electronic cash register further includes receiving means for receiving said historic data and printing means for printing said historic data.

13. An electronic cash register system as claimed in claim 11, wherein said display controller further comprises: historic data display means for displaying said historic data from said historic data storing means in response to a key switch.

14. An electronic cash register system as claimed in claim 1, wherein said display controller further comprises: storing means for storing group codes, each code indicating resemble types of said articles, and said displaying means displaying said result at different areas in accordance with said group codes.

15. An electronic cash register system as claimed in claim 1, wherein said display controller includes:
stocked article data storing means for storing the number of articles of which the number is predicted by said prediction means;
time limit storing means for storing time limit data of said articles;
passage time measuring means for measuring passed time of said articles of which the number is predicted by said prediction means;
judging means for judging whether said measured passed time of said articles exceeds said time limit data; and
subtracting means for subtracting the number of articles judged that said measured passed time exceeds said time limit data from the number of stocked articles.

16. An electronic cash register system as claimed in claim 6, wherein said display controller further comprises:
display mode switching signal generation means for generating said display mode switching signal in response to a key switch connected to said video kitchen controller.

17. An electronic cash register system as claimed in claim 6, wherein said clock means further generates a date signal indicative of a day of a week, and said selection signal selects one of said different time zone in response to said date signal as said selection signal.

18. An electronic cash register system as claimed in claim 11, wherein said outputting means includes a recording means for recording said historic data in a recording medium.

19. An electronic cash register system as claimed in claim 1, wherein said predetermined interval agrees with said just before unit interval in length.
